(19) United States
(12) Patent Application Publication
(10) Pub. No.: US 2014/0133376 A1
(43) Pub. Date: May 15, 2014

(54) METHOD, APPARATUS, AND COMPUTER PROGRAM PRODUCT FOR ASSOCIATION IDENTIFIER ADDRESSING AND IMPLICIT TARGET WAKE TIME ASSIGNMENT

(71) Applicant: NOKIA CORPORATION, Espoo (FI)

(72) Inventor: Chittabrata Ghosh, Fremont, CA (US)

(73) Assignee: NOKIA CORPORATION, Espoo (FI)

(21) Appl. No.: 13/720,796

(22) Filed: Dec. 19, 2012

Related U.S. Application Data
(63) Continuation-in-part of application No. 13/676,422, filed on Nov. 14, 2012.

(51) Int. Cl. H04W 52/02

(52) U.S. Cl. 370/311

(57) ABSTRACT

Method, apparatus, and computer program product embodiments of the invention are disclosed for association identifier addressing and target wake time assignment employable, for example, in connection with wireless networks. In an example embodiment of the invention, a method comprises: receiving, at a device, a first message from an access node, wherein said first message comprises a first association identifier and a first addressing mode indication; determining, at the device, a first target wake time correlating to the first association identifier and the first addressing mode indication; receiving, at the device, a second message from the access node, wherein said second message comprises a second association identifier and a second addressing mode indication; and determining, at the device, a second target wake time correlating to the second association identifier and the second addressing mode indication.

This application is a continuation-in-part of U.S. application Ser. No. 13/676,422, entitled “Method, Apparatus, and Computer Program Product for Implicit Target Wake Time Assignment,” which was filed on Nov. 14, 2012 and is incorporated herein by reference.

### FIELD

The field of the invention relates to association identifier addressing and target wake time assignment employable, for example, in connection with wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth is an example of a short-range wireless technology quickly gaining acceptance in the marketplace. In addition to Bluetooth other popular short-range communication technologies include Bluetooth Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features and advantages that make them appropriate for various applications.

### SUMMARY

Method, apparatus, and computer program product embodiments of the invention are disclosed for association identifier addressing and target wake time assignment employable, for example, in connection with wireless networks.

In an example embodiment of the invention, a method comprises:

receiving, at a device, a first message from an access node, wherein said first message comprises a first association identifier and a first addressing mode indication, and wherein said first message does not comprise explicit target wake time indication;

determining, at the device, a first target wake time correlating to the first association identifier and the first addressing mode indication, wherein there is a predetermined correlation between:
the first target wake time; and
the first association identifier and the first addressing mode indication;

receiving, at the device, a second message from the access node, wherein said second message comprises a second association identifier and a second addressing mode indication, and wherein said second message does not comprise explicit target wake time indication; and

determining, at the device, a second target wake time correlating to the second association identifier and the second addressing mode indication, wherein there is a predetermined correlation between:
the second target wake time; and
the second association identifier and the second addressing mode indication.

In an example embodiment of the invention, the method further comprises determining, at the device, to send to the access node specification of at least one desired target wake time.

In an example embodiment of the invention, the method further comprises wherein the second message is received via an association identifier reassignment phase.

In an example embodiment of the invention, the method further comprises wherein the device receives the second association identifier without experiencing disassociation.

In an example embodiment of the invention, the method further comprises wherein the first message is received during association.

In an example embodiment of the invention, the method further comprises wherein one or more of:

said first message further comprises a duration corresponding to the first association identifier; and

said second message further comprises a duration corresponding to the second association identifier.

In an example embodiment of the invention, a method comprises:

receiving, at an access node from a first device, a first specification of at least one desired target wake time;

selecting, at the access node, a first addressing mode, wherein the selection takes into account one or more of:
at least one of said first specified target wake times; and
at least one already assigned target wake time;

determining, at the access node, to dispatch to the first device a first message, wherein said first message comprises a first association identifier and a first addressing mode indication, wherein said first addressing mode indication corresponds to the selected first addressing mode, and wherein said first message does not comprise explicit target wake time indication;

receiving, at the access node from a second device, a second specification of at least one desired target wake time;

selecting, at the access node, a second addressing mode, wherein the selection takes into account one or more of:
at least one of said second specified target wake times; and
at least one already assigned target wake time; and

determining, at the access node, to dispatch to the first device a second message, wherein said second message comprises a second association identifier and a second addressing mode indication, wherein said second addressing mode indication corresponds to the selected second addressing mode, and wherein said second message does not comprise explicit target wake time indication.

In an example embodiment of the invention, the method further comprises wherein the second message is dispatched via an association identifier reassignment phase, and wherein said association identifier reassignment phase avoids device disassociation.

In an example embodiment of the invention, the method further comprises wherein said first message is dispatched during association.

In an example embodiment of the invention, the method further comprises wherein one or more of:

said first message further comprises a duration corresponding to the first association identifier; and

said second message further comprises a duration corresponding to the second association identifier.

In an example embodiment of the invention, an apparatus comprises:

at least one processor; and

at least one memory including computer program code, the at least one memory and the computer program code configured to, with the at least one processor, cause the apparatus at least to perform:

receive, at the apparatus, a first message from an access node, wherein said first message comprises a first association identifier and a first addressing mode indication, and wherein said first message does not comprise explicit target wake time indication;

determine, at the apparatus, a first target wake time correlating to the first association identifier and the first addressing mode indication, wherein there is a predetermined correlation between:
the first target wake time; and
the first association identifier and the first addressing mode indication;

receive, at the apparatus, a second message from the access node, wherein said second message comprises a second association identifier and a second addressing mode indication, and wherein said second message does not comprise explicit target wake time indication; and

determine, at the apparatus, a second target wake time correlating to the second association identifier and the second addressing mode indication, wherein there is a predetermined correlation between:
the second target wake time; and
the second association identifier and the second addressing mode indication.

In an example embodiment of the invention, the apparatus further comprises wherein the at least one memory and the computer program code are further configured to, with the at least one processor, cause the apparatus to determine, at the apparatus, to send to the access node specification of at least one desired target wake time.

In an example embodiment of the invention, the apparatus further comprises wherein the second message is received via an association identifier reassignment phase.

In an example embodiment of the invention, the apparatus further comprises wherein the apparatus receives the second association identifier without experiencing disassociation.

In an example embodiment of the invention, the apparatus further comprises wherein the first message is received during association.

In an example embodiment of the invention, the apparatus further comprises wherein one or more of:

said first message further comprises a duration corresponding to the first association identifier; and

said second message further comprises a duration corresponding to the second association identifier.

In an example embodiment of the invention, an apparatus comprises:

at least one processor; and

at least one memory including computer program code, the at least one memory and the computer program code configured to, with the at least one processor, cause the apparatus at least to perform:

receive, at the apparatus from a first device, a first specification of at least one desired target wake time;

select, at the apparatus, a first addressing mode, wherein the selection takes into account one or more of:
at least one of said first specified target wake times; and
at least one already assigned target wake time;

determine, at the apparatus, to dispatch to the first device a first message, wherein said first message comprises a first association identifier and a first addressing mode indication, wherein said first addressing mode indication corresponds to the selected first addressing mode, and wherein said first message does not comprise explicit target wake time indication;

receive, at the apparatus from a second device, a second specification of at least one desired target wake time;

select, at the apparatus, a second addressing mode, wherein the selection takes into account one or more of:
at least one of said second specified target wake times; and
at least one already assigned target wake time; and

determine, at the apparatus, to dispatch to the first device a second message, wherein said second message comprises a second association identifier and a second addressing mode indication, wherein said second addressing mode indication corresponds to the selected second addressing mode, and wherein said second message does not comprise explicit target wake time indication.

In an example embodiment of the invention, the apparatus further comprises wherein the second message is dispatched via an association identifier reassignment phase, and wherein said association identifier reassignment phase avoids device disassociation.

In an example embodiment of the invention, the apparatus further comprises wherein said first message is dispatched during association.

In an example embodiment of the invention, the apparatus further comprises wherein one or more of:

said first message further comprises a duration corresponding to the first association identifier; and

said second message further comprises a duration corresponding to the second association identifier.

In this manner, embodiments of the invention provide association identifier addressing and target wake time assignment functionality employable, for example, in connection with wireless networks.

### DESCRIPTION OF THE FIGURES

FIG. 1 discloses a deployment scenario for association identifier addressing and implicit target wake time (TWT) assignment functionality in accordance with at least one example embodiment of the present invention.

FIG. 2A discloses a hierarchical addressing for association identifier addressing and implicit TWT assignment functionality in accordance with at least one example embodiment of the present invention.

FIG. 2B discloses a further hierarchical addressing for association identifier addressing and implicit TWT assignment functionality in accordance with at least one example embodiment of the present invention.

FIG. 2C discloses an additional hierarchical addressing for association identifier addressing and implicit TWT assignment functionality in accordance with at least one example embodiment of the present invention.

FIG. 3 discloses TWT hierarchical addressing correspondence in accordance with at least one example embodiment of the present invention.

FIG. 4 discloses an Association Identifier (AID)-TWT correlation calculation by a station (STA) in accordance with at least one example embodiment of the present invention.

FIG. 5 discloses an AID-TWT correlation calculation by an access point (AP) in accordance with at least one example embodiment of the present invention.

FIG. 6 discloses a further AID-TWT correlation calculation by a STA in accordance with at least one example embodiment of the present invention.

FIG. 7 discloses a further AID-TWT correlation calculation by an AP in accordance with at least one example embodiment of the present invention.

FIG. 8A discloses a further TWT hierarchical addressing correspondence in accordance with at least one example embodiment of the present invention.

FIG. 8B discloses another TWT hierarchical addressing correspondence in accordance with at least one example embodiment of the present invention.

FIG. 8C discloses an additional TWT hierarchical addressing correspondence in accordance with at least one example embodiment of the present invention.

FIG. 9A discloses a further TWT hierarchical addressing correspondence in accordance with at least one example embodiment of the present invention.

FIG. 9B discloses another TWT hierarchical addressing correspondence in accordance with at least one example embodiment of the present invention.

FIG. 9C discloses an additional TWT hierarchical addressing correspondence in accordance with at least one example embodiment of the present invention.

FIG. 10 discloses a computer in accordance with at least one example embodiment of the present invention.

FIG. 11A discloses a functional block diagram in accordance with at least one example embodiment of the present invention.

FIG. 11B discloses a flow diagram in accordance with at least one example embodiment of the present invention.

FIG. 11C discloses a further flow diagram in accordance with at least one example embodiment of the present invention.

FIG. 12 discloses a further computer in accordance with at least one example embodiment of the present invention.

### DISCUSSION OF EXAMPLE EMBODIMENTS OF THE INVENTION

### Association Identifier Addressing and Implicit Target Wake Time Assignment—General Functionality

General association identifier (AID) addressing and implicit target wake time (TWT) assignment functionality according to at least one example embodiment will now be discussed. As discussed in greater detail herein, via such functionality a station (STA) (e.g., a non-traffic indication map (TIM) station) receiving (e.g., during association) an AID, and in various embodiments also a discussed-herein duration and/or a discussed-herein AID addressing hierarchy mode indicator (e.g., conveyed via AID bits), is able to determine therefrom its TWT (e.g., stated as an offset relative to a target beacon transmission time (TBTT)). The STA does not receive explicit indication of its TWT, and as such does not receive explicit indication of its TWT during association. Optionally, the STA specifies (e.g., during association) one or more desired TWTs.

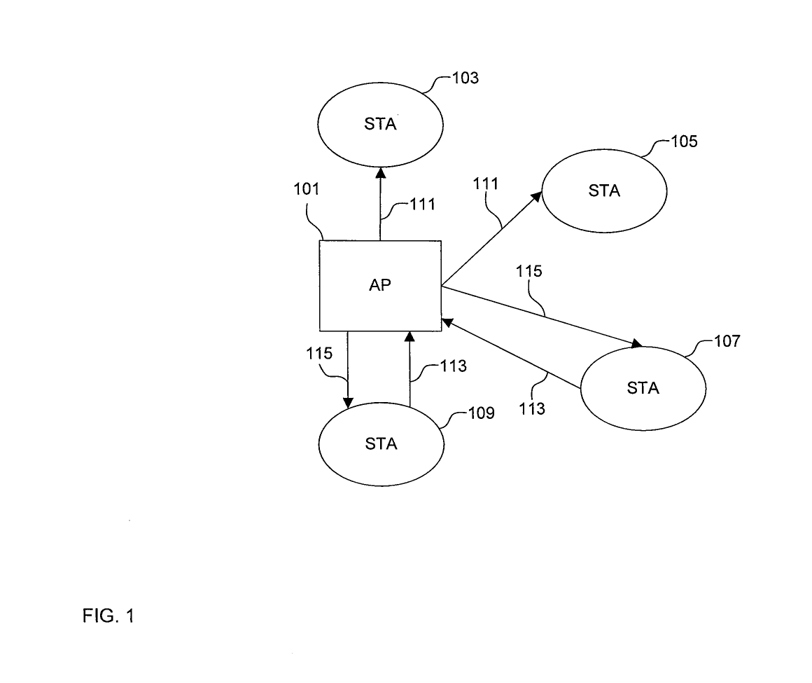

As an illustrative example of such functionality, shown in FIG. 1 is a deployment scenario, according to at least one example embodiment, for the AID addressing and implicit TWT assignment functionality now discussed. Shown in FIG. 1 are Institute of Electrical and Electronics Engineers (IEEE) 802.11ah-capable access point (AP) (101), TIM STAs 103 and 105, and non-TIM STAs 107 and 109.

Further according to the illustrative example, AP (101) buffers downlink data for STAs 103-109. TIM STAs 103 and 105 come to learn that such buffered downlink data awaits them by decoding beacons (111) (e.g., long and short beacons) which are dispatched by AP (101). Non-TIM STAs 107 and 109, which as a non-limiting example are power constrained, do not decode such beacons. By not decoding beacons non-TIM STAs 107 and 109 garner a number of potential benefits including power saving. As a non-limiting example, one or more of STAs 103-109 are sensors.

Still further according to the illustrative example, non-TIM STAs 107 and 109 each awaken (e.g., exit a power save mode) at its corresponding TWT and, as appropriate, perform either or both of dispatching (113) to AP (101) uplink traffic which it has buffered while asleep (e.g., while in a power save mode) and retrieving (115) downlink data from AP (101) which AP (101) has buffered while the corresponding non-TIM STA was asleep (e.g., in a power save mode). Optionally, a STA confirms the absence of traffic (e.g., via carrier sense multiple access (CSMA)) prior to uplink and/or downlink of buffered data at its TWT. In the case where a STA of non-TIM STAs 107 and 109 when awakening both dispatches to AP (101) buffered uplink data and retrieves from AP (101) buffered downlink data, such operations optionally occur in parallel. In the case of additional non-TIM STAs (e.g., non-TIM STAs beyond non-TIM STAs 107 and 109), such STAs, as a non-limiting example, analogously dispatch buffered data and/or received buffered data from AP (101) during their corresponding TWTs.

Also according to the illustrative example, a STA (e.g., a non-TIM STA) is the subject of implicit TWT assignment based on AID addressing (e.g., IEEE 802.11ah AID addressing). As a non-limiting example, the AID addressing is a hierarchical addressing. The AID addressing may comprise one or more pages. Each page may comprise one or more blocks. Each block may comprise one or more sub-blocks (SBs). Each SB may comprise one or more AID address locations, with each such AID address location corresponding to the AID of a STA (e.g., with there being AIDs ranging from 1-2007 with each of multiple STAs receiving one of the AIDs from that 1-2007 range, with there being AIDs ranging from 1-2048 in one page with each of multiple STAs receiving one of the AIDs from that 1-2048 range, and/or with there being AIDs ranging from 1-8192 with each of multiple STAs receiving AIDs from that 1-8192 range). In at least one embodiment, there can be more or less hierarchy levels in AID addressing.

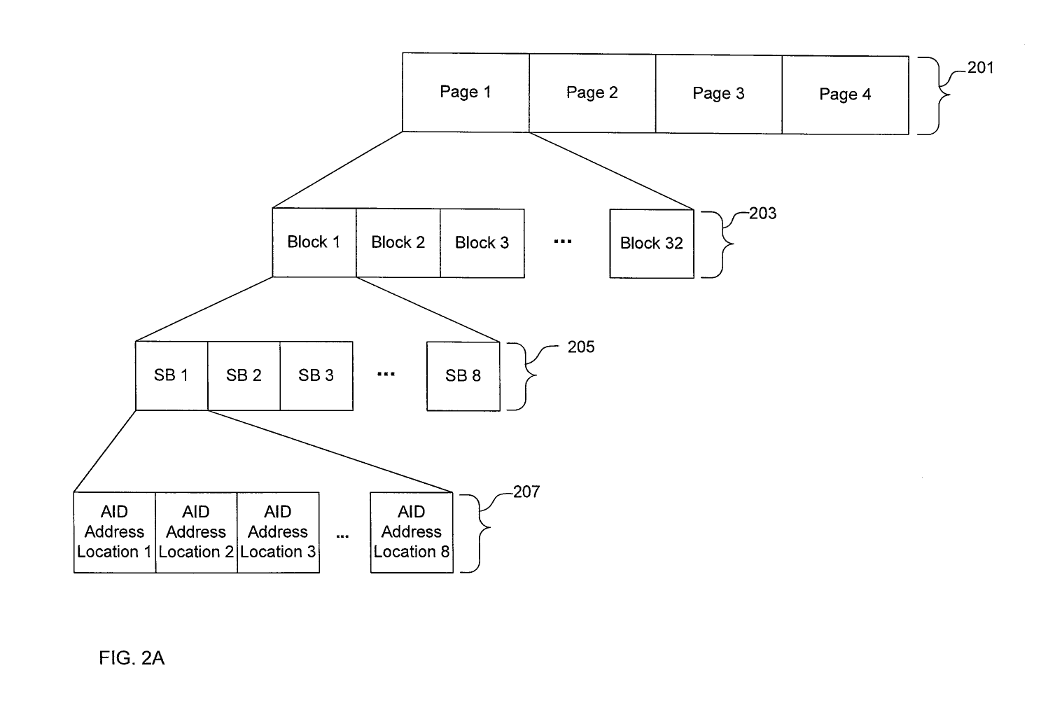

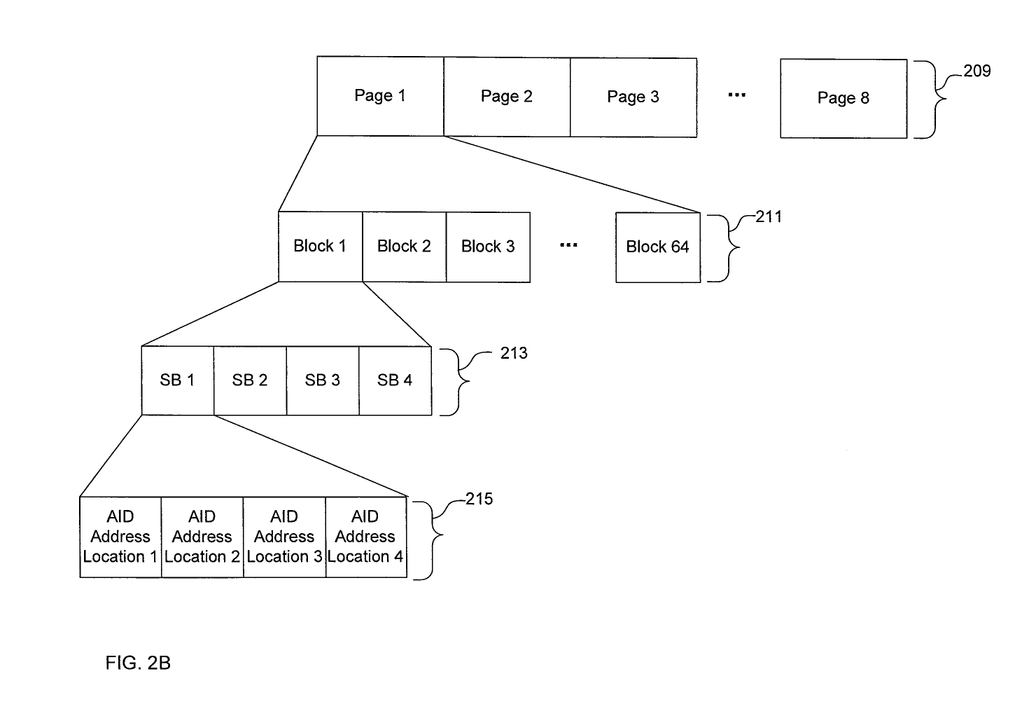

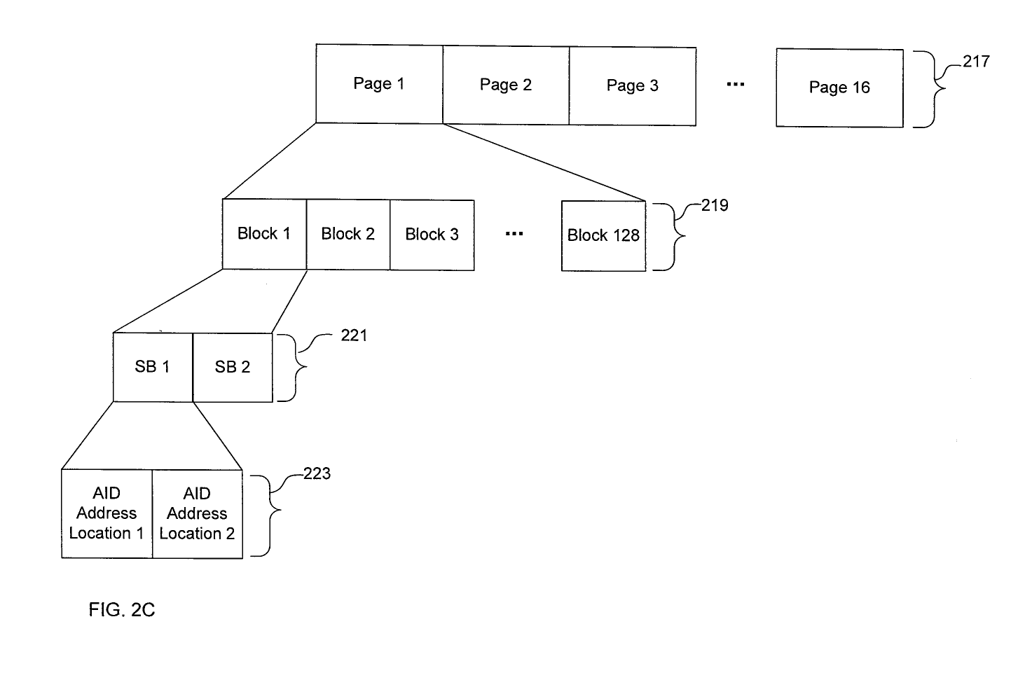

As one non-limiting example, with reference to FIG. 2A which shows a hierarchical addressing, according to at least one example embodiment, for the AID addressing and implicit TWT assignment functionality discussed herein, such hierarchy is four pages (201) (e.g., corresponding to a 2 bit page index of a 13-bit AID), 32 blocks within each page (203) (e.g., corresponding to a 5 bit block offset of a 13-bit AID), eight SBs within each block (205) (e.g., corresponding to a 3 bit SB offset of a 13-bit AID), and eight AID address locations (207) (e.g., corresponding to a 3 bit SB bitmap of a 13-bit AID) in each SB, with each such AID address location corresponding to the AID of a STA. As is discussed in greater detail herein, such an AID, considered in view of its corresponding AID address location, correlates to a TWT.

As a second non-limiting example, with reference to FIG. 2B which shows a further hierarchical addressing, according to at least one example embodiment, for the AID addressing and implicit TWT assignment functionality discussed herein, such hierarchy is eight pages (209) (e.g., corresponding to a 3 bit page index of a 13-bit AID), 64 blocks within each page (211) (e.g., corresponding to a 6 bit block offset of a 13-bit AID), four SBs within each block (213) (e.g., corresponding to a 2 bit SB offset of a 13-bit AID), and four AID address locations (215) (e.g., corresponding to a 2 bit SB bitmap of a 13-bit AID) in each SB, with each such AID address location corresponding to the AID of a STA. As is discussed in greater detail herein, such an AID, considered in view of its corresponding AID address location, correlates to a TWT.

As a third non-limiting example, with reference to FIG. 2C which shows an additional hierarchical addressing, according to at least one example embodiment, for the AID addressing and implicit TWT assignment functionality discussed herein, such hierarchy is sixteen pages (217) (e.g., corresponding to a 4 bit page index of a 13-bit AID), 128 blocks within each page (219) (e.g., corresponding to a 7 bit block offset of a 13-bit AID), two SBs within each block (221) (e.g., corresponding to a 1 bit SB offset of a 13-bit AID), and two AID address locations (223) (e.g., corresponding to a 1 bit SB bitmap of a 13-bit AID) in each SB, with each such AID address location corresponding to the AID of a STA. As is discussed in greater detail herein, such an AID, considered in view of its corresponding AID address location, correlates to a TWT.

Additionally according to the illustrative example, the hierarchical addressing of FIG. 2A corresponds to a first AID addressing hierarchy mode, the hierarchical addressing of FIG. 2B corresponds to a second AID addressing hierarchy mode, and the hierarchical addressing of FIG. 2C corresponds to a third AID addressing hierarchy mode.

Further according to the illustrative example, AID addressing hierarchy mode indicators are defined for AID addressing hierarchy modes. As a non-limiting example, such a mode indicator is conveyed via the two most significant bits of an AID and/or via a 2-bit mode selection field of an AID. As a further non-limiting example, the bits “00” convey the AID addressing hierarchy mode of FIG. 2A, the bits “01” convey the AID addressing hierarchy mode of FIG. 2B, the bits “10” convey the AID addressing hierarchy mode of FIG. 2C, and the bits “11” are considered reserved.

The implementation of functionality discussed herein yields a number of potential benefits including allowing for a non-TIM STA to learn of its corresponding TWT without receiving explicit indication thereof from a corresponding AP during association, providing for the saving of some or all of the AP to STA data traffic corresponding to such explicit TWT indication, and/or employing an AID addressing hierarchy well-suited to an at-hand implicit target wake time assignment scenario (e.g., well-suited to maximizing compliance with STA requests for particular TWTs). As a non-limiting example, of a two octets for such data traffic, all two octets or a portion of those two octets (e.g., 1.5 octets) are saved.

### Association Identifier Addressing and Implicit Target Wake Time Assignment—Non-Signaled Duration Functionality

Association identifier addressing and implicit target wake time assignment non-signaled duration functionality according to at least one example embodiment will now be discussed. As discussed in greater detail herein, via such functionality a STA (e.g., a non-TIM station) receiving (e.g., during association) an AID, and in various embodiments an AID addressing hierarchy mode indicator (e.g., conveyed via AID bits), is able to determine therefrom its TWT (e.g., stated as an offset relative to a TBTT), with the duration discussed herein being set and not being signaled (e.g., not being signaled during association). The STA does not receive explicit indication of its TWT, and as such does not receive explicit indication of its TWT during association. Optionally, the STA specifies to a corresponding AP (e.g., during association) one or more desired TWTs.

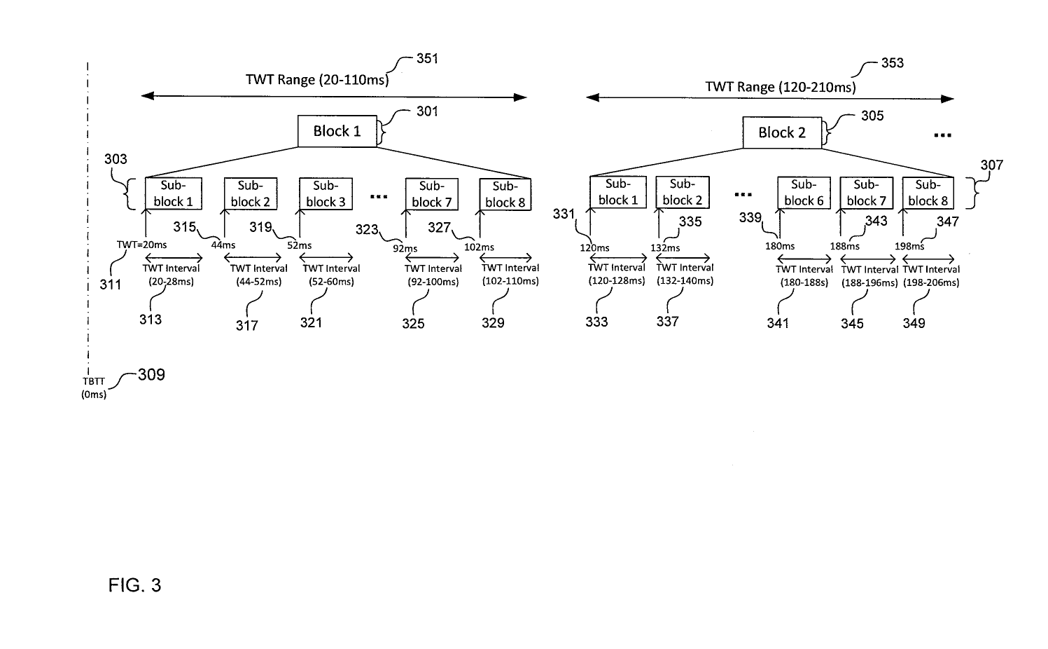

As an illustrative example of such functionality, with reference to FIG. 3, which shows TWT hierarchical addressing correspondence according to at least one example embodiment, within each block (301, 305), there are eight SBs (303, 307) and within each such SB eight AID address locations. A TWT interval is established for each SB. The TWT interval specifies a time span such that for each address location within that block there is a corresponding TWT which sits within that time span.

Further according to the illustrative example, the spacing between such TWTs is in accordance with a set duration. In connection with the non-signaled duration functionality now discussed, all such TWTs are in accordance with the same set duration (e.g., 1 ms). Optionally, a TWT range is established for each block. The TWT range for a block spans over the entire duration of the TWT intervals for the SBs of that block. The time span for each SB's interval begins at an established initial value (e.g., stated in ms and/or as an offset relative to a TBTT) and ends at an end value which flows from that initial value, the number of AID address locations per corresponding SB, and the set duration. The value (e.g., in ms) for such a time span flows from the number of AID address locations per corresponding SB and the set duration. As an example, such span is 8 ms in the case of eight AID address locations per corresponding SB and a set duration of 1 ms. As noted, the TWT range for a block spans over the entire duration of the TWT intervals for the SBs of that block.

Still further according to the illustrative example, the first time value in a given TWT range for a block is the initial value of the TWT interval of the first SB of that block, and the final time value in that TWT range is the end value of the TWT interval of the last SB of that block. The value (e.g., in ms) of the time span for each block's range flows from the number of SBs in that block, the number of AID address locations per each such SB, and the set duration. As an illustrative example, such block time span is 64 ms in the case of eight SBs in the block, eight AID address locations per each SB, and a set duration of 1 ms.

Also according to the illustrative example, with further reference to FIG. 3 an example of a set duration of 1 ms is depicted. Within block 1 (301) are its eight SBs, SB 1 through SB 8 (303). SB1 of block 1 (301) has an initial value of 20 ms (311) and a TWT interval (313) which spans from 20-28 ms. SB 2 of block 1 (301) has an initial value (315) of 44 ms and a TWT interval (317) which spans from 44-52 ms. SB 3 of block 1 (301) has an initial value (319) of 52 ms and a TWT interval (321) which spans from 52-60 ms. SB 7 of block 1 (301) has an initial value (323) of 92 ms and a TWT interval (325) which spans from 92-100 ms. SB 8 of block 1 (301) has an initial value (327) of 102 ms and a TWT interval (329) which spans from 102-110 ms. TWT range (351) for block 1 (301) spans from 20-110 ms. In the foregoing, the values are stated as an offset relative to TBTT (309).

Additionally according to the illustrative example, with still further reference to FIG. 3 within block 2 (305) are its eight SBs, SB 1 through SB 8 (307). SB1 of block 2 (305) has an initial value of 120 ms (331) and a TWT interval (333) which spans from 120-128 ms. SB 2 of block 2 (305) has an initial value (335) of 132 ms and a TWT interval (337) which spans from 132-140 ms. SB 6 of block 2 (305) has an initial value (339) of 180 ms and a TWT interval (341) which spans from 180-188 ms. SB 7 of block 2 (305) has an initial value (343) of 188 ms and a TWT interval (345) which spans from 188-196 ms. SB 8 of block 2 (305) has an initial value (347) of 198 ms and a TWT interval (349) which spans from 198-206 ms. TWT range (353) for block 2 (305) spans from 120-210 ms. In the foregoing, the values are stated as an offset relative to TBTT (309).

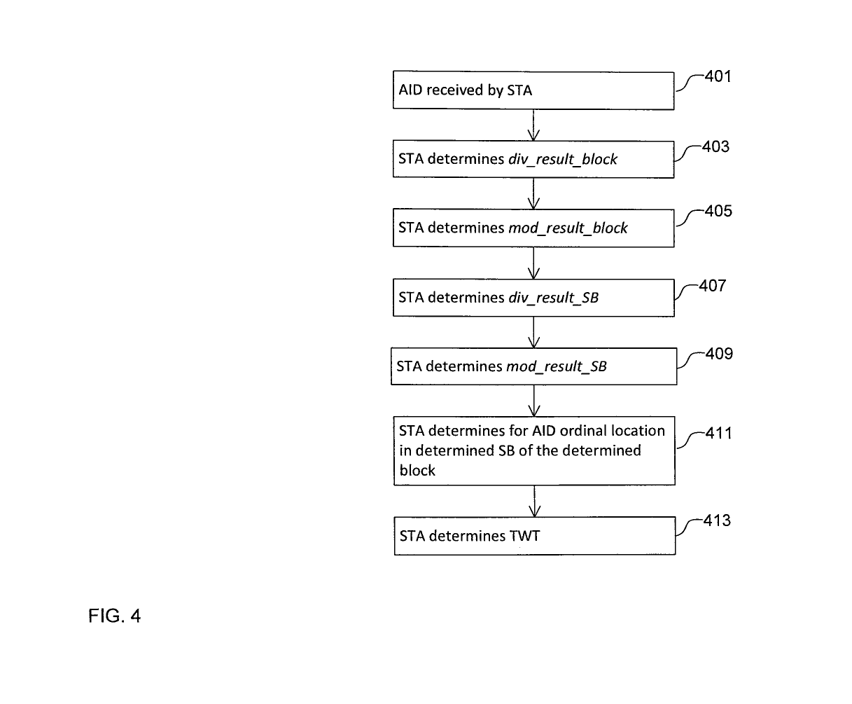

Further according to the illustrative example, with reference to FIG. 4, which shows an AID-TWT correlation calculation by a STA according to at least one example embodiment, a STA (e.g., a non-TIM STA) learns from an AP during association an AID (e.g., an AID of 78, perhaps taken from the range 1-2007, from the range 1-2048, or from the range 1-8192) (401). In embodiments where the STA receives an AID addressing hierarchy mode indicator (e.g., from the AP during association), the STA uses that mode indicator in order to select the appropriate corresponding AID addressing hierarchy. The STA (e.g., by virtue of knowing the corresponding AID addressing hierarchy) is aware of the number of AID address locations per corresponding block (e.g., 64 AID address locations). The STA then performs a DIV operation upon that AID and that number of AID address locations:
div_result_block=STA_AID DIV number_of_AID_per_block (403).

For a STA_AID of 78 and a number_of_AID_per_block of 64, such operation yields a result of 1.

Additionally according to the illustrative example, the STA performs a MOD operation upon that AID and that number of AID address locations:
mod_result_block=STA_AID MOD number_of_AID_per_block (405).

For a STA_AID of 78 and a number_of_AID_per_block of 64, such operation yields a mod_result_block result of 14.

The STA (e.g., by virtue of knowing the corresponding AID addressing hierarchy) is aware of the number of AID address locations per SB (e.g., 8). The STA then performs a DIV operation upon mod_result_block and that number of AID address locations per SB:
div_result_SB=mod_result_block DIV number_of_AID_per_SB (407).

For a mod_result_block of 14 and a number_of_AID_per_SB of 8, such operation yields a result of 1. The STA then performs a MOD operation upon mod_result_block and number_of_AID_per_SB:
mod_result_SB=mod_result_block MOD number_of_AID_per_SB (409).

For a mod_result_block of 14 and a number_of_AID_per_SB of 8, such operation yields a result of 6. From this the STA knows that its AID is the mod_result_SB-th AID in SB (div_result_SB+1) of block (div_result_block+1) (411).

For a mod_result_SB of 6, a div_result_SB of 1, and a div_result_block of 1, the STA finds itself to have the 6th AID in SB 2 of block 2.

Still further according to the illustrative example, the STA determines its TWT (e.g., as an offset relative to a TBTT) as:
TWT=corresponding_initial_value+((mod_result_SB−1)*set_duration) (413).

Further according to the illustrative example, the STA optionally after performing 411 checks whether or not its AID is the first AID in the determined SB. Where the STA finds its AID to be the first AID in the determined SB, it considers its TWT to be corresponding_initial_value and does not perform 413. Where the STA finds its AID to not be the first AID in the determined SB it proceeds to perform 413.

Still further according to the illustrative example, the STA optionally performs AID-TWT correlation precalculation. Accordingly, rather than receiving a particular AID (e.g., during association) and then performing the above-discussed calculations with respect to that particular received AID, the STA precalculates for each of one or more AID values taken from a pool of possible AID values the corresponding TWT. As such, the STA, with receipt of an AID, is able to retrieve the corresponding precalculated TWT.

As to corresponding_initial_value and set_duration, the STA is aware of the set duration and is aware of the initial value for the above-determined SB of the above-determined block. For the initial values discussed in connection with FIG. 3, such determined SB being 2 and such determined block being 2, the corresponding_initial_value is 132 ms. Further, for FIG. 3 the set duration is 1 ms. As such, for such a corresponding_initial_value of 132 ms, a mod_result_SB of 6, and a set duration of 1 ms, so calculating TWT yields a result of 137 ms.

Additionally according to the illustrative example, with additional reference to FIG. 3, SB 1 of block 1 (301) has a TWT interval (313) whose span ends at 28 ms while SB 2 of block 1 (301) has a TWT interval (317) whose span starts at 44 ms, thus yielding a gap from 28 ms to 44 ms. In contrast, SB 2 of block 1 (301) has a TWT interval (317) whose span ends at 52 ms while SB 3 of block 1 (301) has a TWT interval (321) whose span starts at 52 ms, thus not yielding such a gap. As a non-limiting example, such gaps reflect only one or more portions of the beacon period which commences with beacon period start (309) being used for non-TIM STAs, the balance of the beacon period being not used, or being used for other than non-TIM STAs. Examples of such non-TIM STA use include use for TIM STAs having AIDs pulled from a different AID pool space (e.g., pulled from a different particular pool space of AIDs ranging from 1-2007, from 1-2048, or from 1-8192) than the non-TIM STAs whose AIDs indicate TWTs as discussed herein, and/or use for restricted access windows (RAWs).

Also according to the illustrative example, as a further non-limiting example, where non-TIM STAs whose AIDs indicate TWTs as discussed herein and TIM STAs have AIDs pulled from the same AID pool space, certain pages, blocks, and/or corresponding AID address hierarchy are designated for such non-TIM STAs and other pages, blocks, and/or SBs of that AID address hierarchy are designed for such TIM STAs. As such some AIDs from the corresponding pool (e.g., a pool of AIDs ranging from 1-2007 from 1-2048, or from 1-8192) are given to such non-TIM STAs and other AIDs from that pool are given to such TIM STAs. AID-TWT correlation reflects this. As a particular example, a nth SB (e.g., a SB 1) has a TWT interval which ends at x ms (e.g., 16 ms) and a (n+2)th SB (e.g., a SB 3) has a TWT interval which starts at that same x ms (e.g., 16 ms) reflecting the nth SB (e.g., SB 1) and the (n+2)th SB (e.g., SB 3) being for non-TIM STAs and the (n+1)th SB (e.g., SB 2) being for TIM STAs.

Further according to the illustrative example, it is noted that the discussed calculations by which a STA determines the TWT which correlates to its AID are compatible with circumstances wherein AID-TWT correlation is not a linear one within an element (e.g., within a page or block). The presence of such linearity is evidenced by the TWT for a given AID being determinable by solving an equation in the form of TWT=AID+X, where X a commencement value (e.g., where X represents that start of an appropriate TWT range). Such lack of linear correlation arises in situations including those discussed above concerning TIM STAs and non-TIM STAs having AIDs pulled from the same AID pool space, and TIM and non-TIM STAs having AIDs pulled from different AID pool spaces.

Still further according to the illustrative example, it is noted that the AID-TWT calculation discussed above calculated, for an AID of 48, a corresponding TWT (e.g., with TWT being expressed as an offset relative to a TBTT) of 137 ms, a value which correctly takes into account the discussed gaps depicted in FIG. 3. In contrast, an attempt at a pure linear calculation of the TWT (e.g., with TWT being expressed as an offset relative to a TBTT) corresponding to the AID of 78 would prove incompatible with the discussed gaps depicted in FIG. 3. To wit, such a pure linear calculation would involve calculating TWT (e.g., with TWT being expressed as an offset relative to a TBTT) as:

TWT=start_of_range_for_first_block+((AID−1)*set_duration)

With an eye towards FIG. 3, start_of_range_for_first_block is 20 ms, set_duration is 1 ms, and as referenced AID is 78, thus yielding a result of TWT=97 ms rather than the correct value of 137 ms which results from calculation appropriately compatible with the discussed gaps of FIG. 3.

Furthermore according to the illustrative example, it is noted that FIG. 3 and FIG. 4, and the text corresponding thereto, as set forth herein are from the vantage point of a given page of the corresponding AID addressing hierarchy, such that block 1 (301) and block 2 (305) are two blocks (e.g., the first two blocks) of that given page. A STA in receipt of an AID, as one non-limiting example, knows the page at which the AID sits within the corresponding AID addressing hierarchy by direct consideration of the AID itself. As an example, AID values do not reset with a new page and instead run increasingly in value from the first block of the first page to the last block of the last page. As such, the AID value indicates the page in which it sits. As a non-limiting illustration, where AIDs run from 1-8192 and there are four pages, AIDs 1-2048 fall within the first page, AIDs 2049-4096 fall within the second page, AIDs 4097-6144 fall within the third page, and AIDs 6145-8192 fall within the fourth page.

As a second non-limiting example, a STA in receipt of an AID knows the page at which the AID sits by other than direct consideration of the AID itself. For instance, the STA is aware that the AIDs which it receives all fall within one or more specified pages (e.g., stemming from an AID addressing organization which, say, groups STAs according to type in a pagewise fashion). Circumstances to which the functionality of the second non-limiting example are applicable include both circumstances where AID values do reset with a new page and circumstances where AIDs run increasingly in value from the first block of the first page to the last block of the last page.

Additionally according to the illustrative example, as discussed a STA performs calculations in order to determine the TWT (e.g., expressed as an offset relative to a TBTT) which correlates with its received AID. The STA awakens at its TWT to dispatch buffered data to and/or receive buffered data from its AP. The AP is likewise capable of determining, for each of one or more of its STAs, the TWT (e.g., expressed as an offset relative to a TBTT) that correlates with the AID of that STA. Such determination by the AP yields a number of potential benefits including being able to know when to expect exchange of buffered data with a given STA. As a non-limiting example, the AP is not aware of the TWT of such a STA prior to such determination.

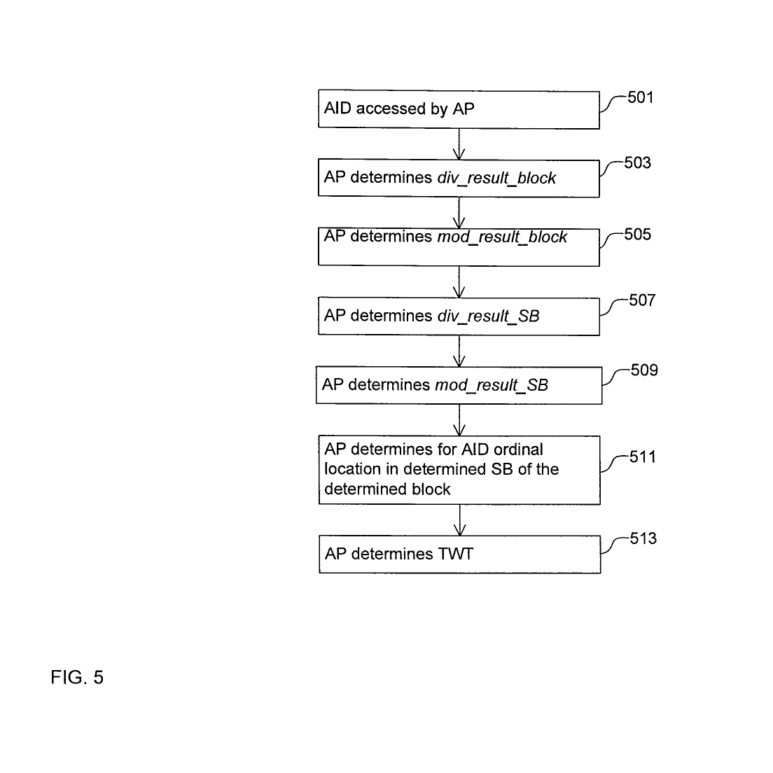

Also according to the illustrative example, such an AP calculates such AID-TWT correlation in a manner analogous to the non-signaled duration AID-TWT correlation calculations discussed above as being performed by a STA. In embodiments where there is more than one AID addressing hierarchy, the AP performs the calculations with respect to an appropriate particular AID addressing hierarchy (e.g., corresponding to an AID addressing hierarchy mode with respect to which the AP is to determine an AID-TWT correlation). As such, with reference to FIG. 5 which shows a AID-TWT correlation calculation by an AP according to at least one example embodiment, the AP accesses (e.g., from a storage location) the AID corresponding to the STA with respect to which TWT is to be determined (501). Next, the AP determines div_result_block (503) in a manner analogous to that discussed above in connection with FIG. 4, determines mod_result_block (505) in a manner analogous to that discussed above in connection with FIG. 4, determines div_result_SB (507) in a manner analogous to that discussed above in connection with FIG. 4, determines mod_result_SB (509) in a manner analogous to that discussed above in connection with FIG. 4, determines for the appropriate AID the ordinal location in the determined SB of the determined block (511) in a manner analogous to that discussed above in connection with FIG. 4, and determines the TWT (513) in a manner analogous to that discussed above in connection with FIG. 4.

Also according to the illustrative example, optionally after performing 511 the AP acts in a manner analogous to that discussed above in connection with FIG. 4 with regard to checking whether or not an AID is the first AID in a determined SB.

Additionally according to the illustrative example, the AP optionally performs AID-TWT correlation precalculation in a manner analogous to that discussed above. As such, the AP, assigning an AID to a particular STA and/or informing a particular STA of its AID, is able to retrieve the corresponding precalculated TWT.

Further according to the illustrative example, a STA, from an AP during association, learns of its AID. The STA is additionally aware of information including the pages or pages within which its received AIDs fall, the number of AID address locations per block, the number of AID address locations per SB, the AID addressing hierarchy, the initial values of intervals, and/or of the set duration at hand. Examples of modes of awareness of such information include one or more of receipt from a corresponding AP and/or server (e.g., at association and/or at one or more times other than association), incorporation into STA program code and/or data stores (e.g., wherein the STA is provided with such information during manufacture, software install, and/or software upgrade), entry by an individual (e.g., by a STA user and/or by a system administrator), and awareness due to other information (e.g., awareness due to knowledge of a corresponding AID addressing hierarchy).

Still further according to the illustrative example, aspects including one or more of the assignment of AIDs to STAs, the number of AID address locations per block, the number of AID address locations per SB, the AID addressing hierarchy, the initial values of intervals, and the set duration are defined in a number of ways including definition by an individual (e.g., by an AP user and/or by a system administrator), definition (e.g., performed at a time prior to a corresponding AID-TWT correlation calculation discussed herein) by a manufacturer, and/or automated definition (e.g., with an AP defining one or more of such values to meet resource scheduling, power saving, and/or other goals). As the AID-TWT correlation calculations discussed herein take into account various of these aspects, such aspect definition serves to define AID-TWT correlation. As a non-limiting example, by defining one or more of AID to STA assignment, the initial values of intervals, and set duration, such an individual, manufacturer, and/or automated definition acts to define AID-TWT correlation.

Also according to the illustrative example, it is noted that a STA (e.g., an 802.11 ah non-TIM STA) conventionally learns explicitly of its TWT during association with an AP (e.g., an 802.11ah AP) via a dispatch of data (e.g., data being two octets in length), from the AP to the STA, which specifies that TWT. In connection with the above-discussed implicit target wake time assignment non-signaled duration functionality, the STA does not receive such explicit TWT indication and instead determines the TWT using the above-discussed received AID. As such, and taking into account that such above-discussed implicit target wake time assignment non-signaled duration functionality does not call for the above-discussed duration to be signaled to the STA, the entirety of the data corresponding to conventional TWT dispatch (e.g., the entire two octets) is saved, thus yielding potential benefits including power saving.

### Association Identifier Addressing and Implicit Target Wake Time Assignment—Signaled Duration Functionality

Association identifier addressing and implicit target wake time assignment signaled duration functionality according to at least one example embodiment will now be discussed. As discussed in greater detail herein, via such functionality a STA (e.g., a non-TIM station) receiving (e.g., during association) an AID, a discussed-herein duration, and in various embodiments an AID addressing hierarchy mode indicator (e.g., conveyed via AID bits) is able to determine therefrom its TWT (e.g., stated as an offset relative to a TBTT). The STA does not receive explicit indication of its TWT, and as such does not receive explicit indication of its TWT during association. Optionally, the STA specifies to a corresponding AP (e.g., during association) one or more desired TWTs.

As an illustrative example of such functionality, an alteration of the above-discussed implicit target wake time assignment non-signaled duration functionality allows for STA determination of TWT in the absence of explicit TWT indication under the circumstance where duration varies on, for instance, a per-SB basis. As a non-limiting example, suppose the duration for a first SB being 1 ms and the duration for a second SB being 2 ms, thus being in contrast to the example described in connection with non-signaled functionality wherein the same 1 ms duration applied to all SBs.

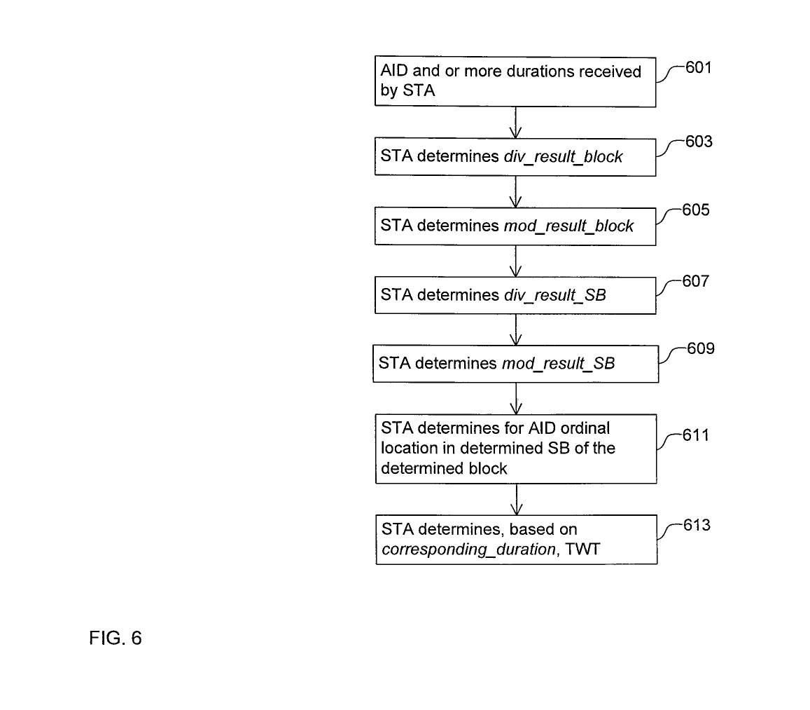

Further according to the illustrative example, with reference to FIG. 6 which shows a further AID-TWT correlation calculation by a STA according to at least one example embodiment, the STA acts in a manner generally analogous to that discussed in connection with 401, but learning from an AP during association not just an AID, and in various embodiments an AID addressing hierarchy mode indicator, but also one or more durations for one or more SBs (601). In embodiments where the STA receives an AID addressing hierarchy mode indicator (e.g., from the AP during association), the STA uses that mode indicator in order to select the appropriate corresponding AID addressing hierarchy. Optionally, the STA only receives the duration for the SB within which its AID is situated. The STA then determines div_result_block (603) in a manner analogous to that discussed above in connection with 403, determines mod_result_block (605) in a manner analogous to that discussed above in connection with 405, determines div_result_SB (607) in a manner analogous to that discussed above in connection with 407, determines mod_result_SB (609) in a manner analogous to that discussed above in connection with 409, and determines for the appropriate AID the ordinal location in the determined SB of the determined block (611) in a manner analogous to the discussed above in connection with 411.

Still further according to the illustrative example, the STA then determines the TWT in a manner generally analogous to that discussed above in connection with 413, but employing in place of set_duration of 413 corresponding_duration, where corresponding_duration is the duration for the 609-determined SB of the 609-determined block (613). As such the STA calculates its TWT (e.g., as an offset relative to a TBTT) as:

TWT=corresponding_initial_value+((mod_result_SB−1)*corresponding_duration).

Additionally according to the illustrative example, returning to the example of FIG. 4 but now employing corresponding_duration and taking the value thereof to be 3 ms for the determined SB of the determined block, taking mod_result_SB to be 6 in connection with the corresponding performance of 609, and taking corresponding_initial_value to remain as 132 ms, and as such not to have been affected by duration differences, yields a result of 147 ms.

Also according to the illustrative example, optionally after performing 611 the STA acts in a manner analogous to that discussed above in connection with FIG. 4 with regard to checking whether or not an AID is the first AID in a determined SB.

Further according to the illustrative example, the STA optionally performs AID-TWT precalculation in a manner analogous to that discussed above. As a non-limiting example, the STA is aware of the duration which would apply to a given AID and employs that duration value in precalculation. As another non-limiting example, the STA performs such precalculation for a given AID with respect to a plurality of possible durations for that AID.

Also according to the illustrative example, as discussed a STA is capable of performing calculations in order to determine the TWT (e.g., expressed as an offset relative to a TBTT) which correlates with its received AID and further taking into account a received duration. The AP is likewise capable of determining, for one or more of its STAs, the TWT the correlates with the AID for that STA and with the appropriate corresponding duration.

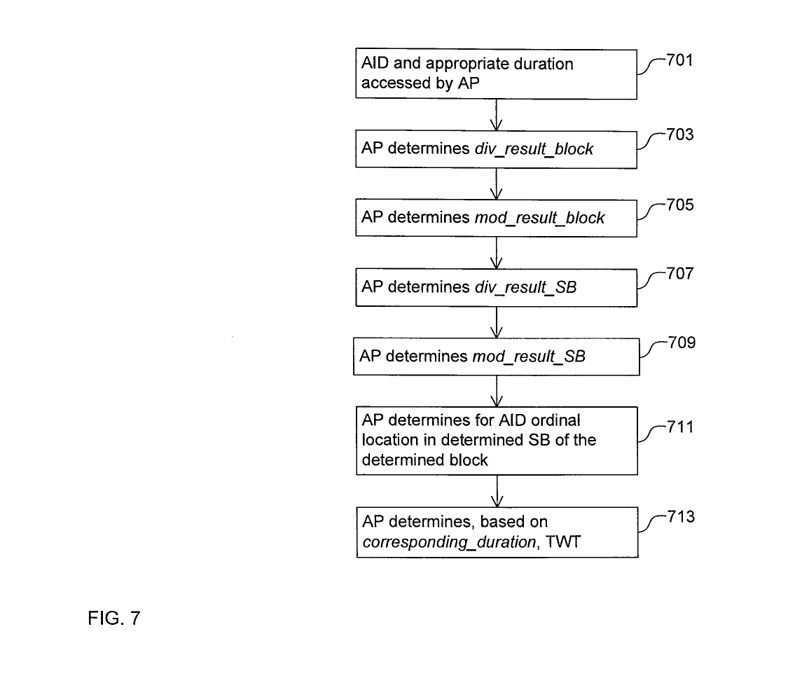

Further according to the illustrative example, such AP calculates such AID-TWT correlation in a manner analogous to the signaled duration AID-TWT correlation calculations discussed herein as being performed by a STA. In embodiments where there is more than one AID addressing hierarchy, the AP performs the calculations with respect to an appropriate particular AID addressing hierarchy (e.g., corresponding to an AID addressing hierarchy mode with respect to which the AP is to determine an AID-TWT correlation). As such, with respect to FIG. 7 which shows a further AID-TWT correlation calculation by an AP according to at least one example embodiment, for each of one or more of its STAs the AP accesses (e.g., from a storage location) the AID and appropriate duration corresponding to the STA with respect to which TWT is to be determined (701). Next, the AP determines div_result_block (703) in a manner analogous to that discussed above in connection with FIG. 6, determines mod_result_block (705) in a manner analogous to that discussed above in connection with FIG. 6, determines div_result_SB (707) in a manner analogous to that discussed above in connection with FIG. 6, determines mod_result_SB (709) in a manner analogous to that discussed above in connection with FIG. 6, determines for the AID the ordinal location in the determined SB of the determined block (711) in a manner analogous to that discussed above in connection with FIG. 6, and determines, based on corresponding_duration, the TWT (713) in a manner analogous to that discussed above in connection with FIG. 6. The AP optionally acts in a manner analogous to that discussed above with regard to checking whether or not an AID is the first AID in a determined SB. The AP optionally performs AID-TWT precalculation in a manner analogous to that discussed above. As a non-limiting example, the AP is aware of the duration which would apply to a given AID and employs that duration in precalculation. As another non-limiting example, the AP performs such precalculation for a given AID with respect to a plurality of possible durations for that AID.

Also according to the illustrative example, it is noted that a STA (e.g., an 802.11 ah non-TIM STA) conventionally learns explicitly of its TWT during association with an AP (e.g., an 802.11ah AP) via a dispatch of data (e.g., data being two octets in length), from the AP to the STA, which specifies that T. In connection with the above-discussed implicit target wake time assignment signaled duration functionality, the STA does not receive such explicit TWT indication and instead determines the TWT using the above-discussed received AID and the above-discussed received duration. As such, and taking into account that such above-discussed implicit target wake time assignment signaled duration functionality calls for the duration to be signaled to the STA (e.g., requiring half an octet), a portion of the data corresponding to conventional TWT dispatch (e.g., a portion of the two octets) is saved, thus yielding potential benefits including power saving. As a non-limiting example, in the case where conventional TWT dispatch requires two octets and duration signaling requires half an octet, 1.5 octets are saved relative to conventional functionality.

### Association Identifier Addressing and Implicit Target Wake Time Assignment—Target Wake Time Management and Association Identifier Addressing Hierarchy Mode Selection Functionality

Association identifier addressing and implicit target wake time assignment, Target Wake Time Management and association identifier addressing hierarchy mode selection functionality according to at least one example embodiment will now be discussed. As discussed in greater detail herein, via such functionality an AP performs implicit TWT assignment and/or reassignment, and evaluates which AID addressing hierarchy mode will allow the AP to best satisfy one or more STAs with respect to TWTs (e.g., where the AP is already employing a particular AID addressing hierarchy mode, the AP considers whether a change in AID addressing hierarchy mode would allow the AP to better satisfy one or more STAs with respect to TWTs). In performing such evaluation the AP considers factors including STA indications of desired TWT (e.g., provided during association) and/or TWTs already assigned to STAs.

As an illustrative example of such functionality, association between an AP (e.g., an AP already employing a particular AID addressing hierarchy mode) and a STA commences (e.g., including the STA sending an association request to the AP). The STA optionally specifies one or more desired TWTs. Where the STA specifies one or more desired TWTs, the AP determines which, if any, of those desired TWTs remain unassigned to any already-associated STAs. The AP consults one or more stores (e.g., one or more local and/or remote stores) wherein the AP keeps track of STA-TWT assignments and determines whether or not any of the STA's desired TWTs are available. Where none of the desired TWTs are available, the AP instead considers the closest in value unassigned TWT.

Also according to the illustrative example, the AP then performs a best AID addressing hierarchy mode determination with respect to one or more of such TWTs found to remain unassigned. As a non-limiting example, the AP performs a best AID addressing hierarchy mode determination with respect to each of such TWTs found to remain unassigned. Where the STA suggests more than one desired TWT, and the AP finds, by performing best AID addressing hierarchy mode determination operations, that employment certain of those TWTs would lead to an AID addressing hierarchy mode change while employment of others of such TWTs would not lead to an addressing mode change, the AP optionally chooses one of the TWTs which would not lead to an addressing mode change. Moreover, where the STA suggests more than one desired TWT and also corresponding preference rankings, the AP optionally takes such rankings into account in selecting a TWT to assign to the STA (e.g., the AP selects the most preferred unassigned TWT).

Further according to the illustrative example, where the STA does not suggest any desired TWTs, the AP chooses one for the STA which remains unassigned and/or which would not lead to an addressing mode change.

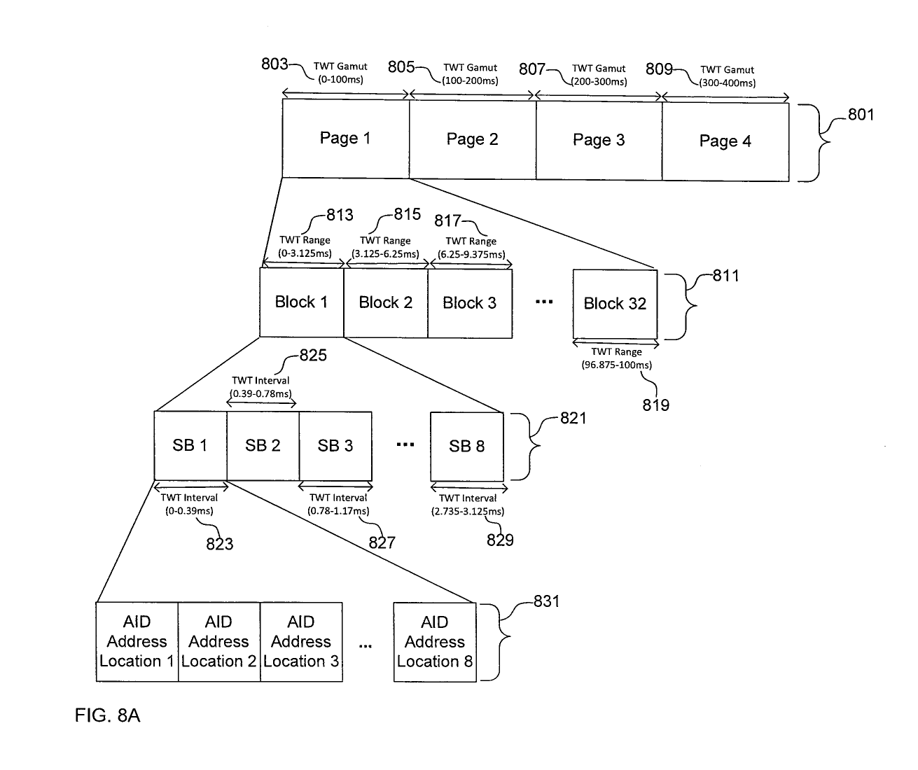

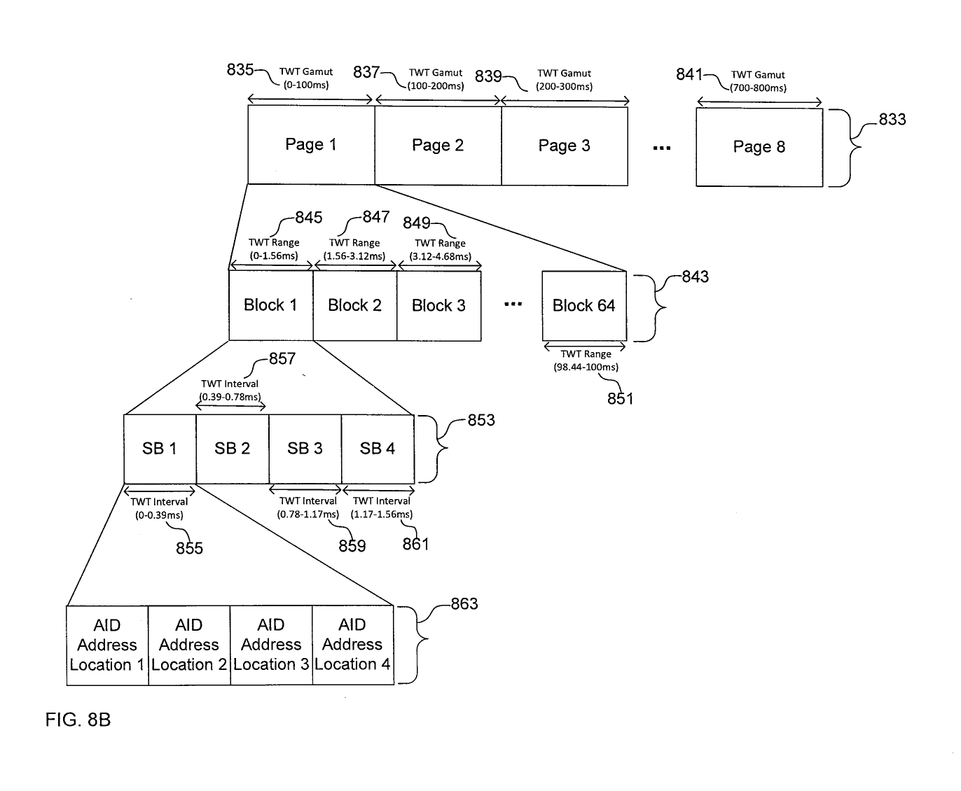

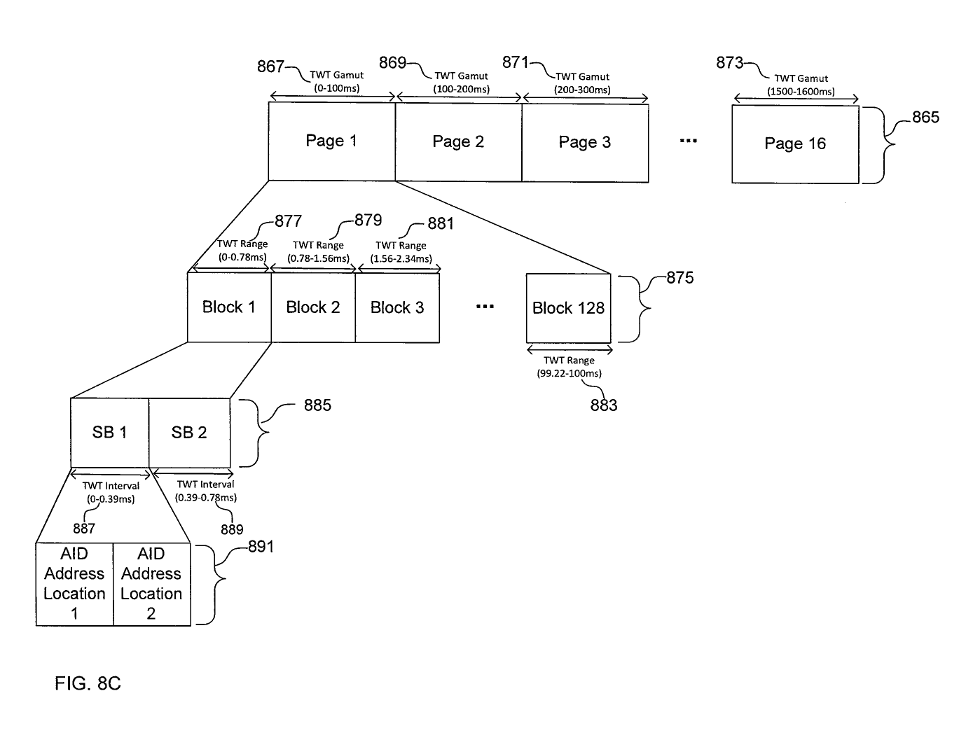

Still further according to the illustrative example, shown in FIGS. 8A-8C are three TWT hierarchical addressing correspondences in accordance with at least one example embodiment. The TWT hierarchical addressing correspondences of FIGS. 8A-8C apply respectively to the AID addressing hierarchy modes of FIGS. 2A-2C.

Also according to the illustrative example, the four pages (801) of FIG. 8A are page 1 through page 4. Page 1 has a TWT gamut (803) which spans from 0-100 ms, page 2 has a TWT gamut (805) which spans from 100-200 ms, page 3 has a TWT gamut (807) which spans from 200-300 ms, and page 4 has a TWT gamut (809) which spans from 300-400 ms. Pages 1-4 each include 32 blocks. Depicted in FIG. 8A are the 32 blocks of page 1 (811), with blocks 1-3 and 32 thereof being explicitly shown, and blocks 4-31 thereof being conveyed via an ellipsis. Block 1 of page 1 has a TWT range (813) which spans from 0-3.125 ms, block 2 of page 1 has a TWT range (815) which spans from 3.125-6.25 ms, block 3 of page 1 has a TWT range (817) which spans from 6.25 to 9.375 ms, and block 32 of page 1 has a TWT range which spans from 96.875-100 ms. Blocks 4-31, which are conveyed via an ellipsis, each have a TWT range which is 3.125 ms wide, the particular spans of each being such so as to appropriately fill the time space starting at 9.375 ms and ending at 96.875 ms.

Additionally according to the illustrative example, Blocks 1-32 each include eight SBs. Depicted in FIG. 8A are the 8 SBs of block 1 (821), with SBs 1-3 and 8 thereof being explicitly shown, and SBs 4-7 thereof being conveyed via an ellipsis. SB 1 of block 1 has a TWT interval (823) which spans from 0-0.39 ms, SB 2 of block 1 has a TWT interval (825) which spans from 0.39-0.78 ms, SB 3 of block 1 has a TWT interval (827) which spans from 0.78-1.17 ms, and SB 8 of block 1 has a TWT interval which spans from 2.735 ms to 3.125 ms. SBs 4-7, which are conveyed via an ellipsis, each have a TWT interval which is 0.39 ms wide, the particular spans of each being such as to appropriately fill the time space starting at 1.17 ms and ending at 2.735 ms.

Further according to the illustrative example, SBs 1-8 each include eight AID address locations. Depicted in FIG. 8A are the eight AID address locations of SB 1 (831), which AID address locations 1-3 and 8 thereof being explicitly shown, and AID address locations 4-7 being conveyed via en ellipsis.

Still further according to the illustrative example, the eight pages (833) of FIG. 8B are page 1-8, with pages 1-3 and 8 being explicitly shown, and pages 4-7 being conveyed via an ellipsis. Page 1 has a TWT gamut (835) which spans from 0-100 ms, page 2 has a TWT gamut (837) which spans from 100-200 ms, page 3 has a TWT gamut (839) which spans from 200-300 ms, and page 8 has a TWT gamut (841) which spans from 700-800 ms. Pages 4-7, which are conveyed via an ellipsis, each have a TWT gamut which is 100 ms wide, the particular spans of each being such as to appropriately fill the time space starting at 300 ms and ending at 700 ms.

Additionally according to the illustrative example, pages 1-8 each include 64 blocks. Depicted in FIG. 8B are the 64 blocks of page 1 (843), with blocks 1-3 and 64 thereof being explicitly shown, and blocks 4-63 thereof being conveyed via an ellipsis. Block 1 of page 1 has a TWT range (845) which spans from 0-1.56 ms, block 2 of page 1 has a TWT range (847) which spans from 1.56-3.12 ms, block 3 of page 1 has a TWT range (849) which spans from 3.12-4.68 ms, and block 64 of page 1 has a TWT range (851) which spans from 98.44-100 ms. Blocks 4-63, which are conveyed via an ellipsis, each have a TWT range which is 1.56 ms wide, the particular spans of each being so as to appropriately fill the time space starting at 4.68 ms and ending at 98.44 ms.

Also according to the illustrative example, blocks 1-64 each include four SBs. Depicted in FIG. 8B are the four SBs of block 1 (853). SB 1 of block 1 has a TWT interval (855) which spans from 0-0.39 ms, SB 2 of block 1 has a TWT interval (857) which spans from 0.39-0.78 ms, SB 3 of block 1 has a TWT interval (859) which spans from 0.78-1.17 ms, and SB 4 of block 1 has a TWT interval (861) which spans from 1.17-1.56 ms. SBs 1-4 each include four AID address locations. Depicted in FIG. 8B are the four AID address locations of SB 1 (863).

Further according to the illustrative example, the sixteen pages (865) of FIG. 8C are page 1-16, with pages 1-3 and 16 being explicitly shown, and pages 4-15 being conveyed via an ellipsis. Page 1 has a TWT gamut (867) which spans from 0-100 ms, page 2 has a TWT gamut (869) which spans from 100-200 ms, page 3 has a TWT gamut (871) which spans from 200-300 ms, and page 16 has a TWT gamut (873) which spans from 1500-1600 ms. Pages 4-15, which are conveyed via an ellipsis, each have a TWT gamut which is 100 ms wide, the particular spans of each being such as to appropriately fill the time space starting at 300 ms and ending at 1500 ms.

Still further according to the illustrative example, pages 1-16 each include 128 blocks. Depicted in FIG. 8C are the 128 blocks of page 1 (875), with blocks 1-3 and 128 thereof being explicitly shown, and blocks 4-127 thereof being conveyed via an ellipsis. Block 1 of page 1 has a TWT range (877) which spans from 0-0.78 ms, block 2 of page 1 has a TWT range (879) which spans from 0.78-1.56 ms, block 3 of page 1 has a TWT range (881) which spans from 1.56-2.34 ms, and block 128 of page 1 has a TWT range (883) which spans from 99.22-100 ms. Blocks 4-127, which are conveyed via an ellipsis, each have a TWT range which is 0.78 ms wide, the particular spans of each being so as to appropriately fill the time space starting at 2.34 ms and ending at 99.22 ms.

Additionally according to the illustrative example, blocks 1-128 each include two SBs. Depicted in FIG. 8C are the two SBs of block 1 (885). SB 1 of block 1 has a TWT interval (887) which spans from 0-0.39 ms. SB 2 of block 1 has a TWT interval (889) which spans from 0.39-0.78 ms. SBs 1 and 2 each include two AID address locations. Depicted in FIG. 8C are the two AID address locations of SB 1 (891).

Also according to the illustrative example, factors considered by the AP in evaluating the AID addressing hierarchy mode to be employed include STA indications of desired TWTs and/or TWTs already assigned to STAs. As such, as a non-limiting example the AP in considering the TWT hierarchical addressing correspondences of FIGS. 8A-8C relative to one another in one aspect discovers that the hierarchical addressing correspondence of FIG. 8A, by virtue of having eight AID address locations for SB 1 of block 1 of page 1, allows eight STAs to have TWTs within the TWT time span 0-0.39 ms, but, by virtue of having merely four 100 ms wide pages, limits STAs to having TWTs within the time span 0-400 ms.

Further according to the illustrative example, in considering the TWT hierarchical addressing correspondences of FIGS. 8A-8C relative to one another the AP in a second aspect discovers that the hierarchical addressing correspondence of FIG. 8B, by virtue of having four AID address locations for SB 1 of block 1 of page 1, allows four STAs to have TWTs within the time span 0-0.39 ms—therefore only half the number of STAs which the hierarchical addressing correspondence of FIG. 8A was able to accommodate within that time span. On the other hand, the hierarchical addressing correspondence of FIG. 8B, by virtue of having eight 100 ms wide pages, allows STAs to have TWTs within a time span of 0-800 ms, outstripping the 0-400 ms span provided for by the hierarchical addressing correspondence of FIG. 8A.

Still further according to the illustrative example, in considering the TWT hierarchical addressing correspondences of FIGS. 8A-8C relative to one another the AP in a third aspect discovers that the hierarchical addressing correspondence of FIG. 8C, by virtue of having two AID address locations for SB 1 of block 1 of page 1, allows only two STAs to have TWTs within the time span 0-0.39 ms—therefore only half the number of STAs which the hierarchical addressing correspondence of FIG. 8B was able to accommodate within that time span and only one quarter of the number of STAs which the hierarchical addressing correspondence of FIG. 8A was able to accommodate within that time span. On the other hand, the hierarchical addressing correspondence of FIG. 8C, by virtue of having sixteen 100 ms wide pages, allows STAs to have TWTs within a time span of 0-1600 ms, outstripping both the 0-400 ms span provided for by the hierarchical addressing correspondence of FIG. 8A and the 0-800 ms span provided for by the hierarchical addressing correspondence of FIG. 8B.

Additionally according to the illustrative example, the AP chooses amongst the hierarchical addressing correspondence of FIG. 8A which corresponds to a first AID addressing hierarchy mode, the hierarchical addressing correspondence of FIG. 8B which corresponds to a second AID addressing hierarchy mode, and the hierarchical addressing correspondence of FIG. 8C which corresponds to a third AID addressing hierarchy mode depending on the circumstances at hand such as STA indications of desired TWTs and/or TWTs already assigned to STAs. As such, where a large portion of STAs have and/or desire TWTs within the span 0-400 ms, the AP selects the first AID addressing hierarchy mode. Where the TWTs held and/or desired by STAs are more evenly distributed within the span 0-1600 ms, the AP selects the third AID addressing hierarchy mode. For circumstances of held and/or desired STA TWTs falling between the two aforementioned, the AP selects the middle ground of the second AID addressing hierarchy mode.

Also further according to the illustrative example, the AP is optionally able to perform one or more of TWT reassignment wherein new TWTs are provided to STAs already possessing TWTs, and deciding the extent to which to meet STA requests for particular desired TWTs received from STA which do not already possess TWTs. As such, consideration of the addressing hierarchy mode to employ is performed so as to choose the addressing mode which allows as many as possible STAs already possessing TWTs to keep those TWTs and/or which allows as many as possible STAs not already possessing TWTs to receive TWTs which they desire. For instance, where the majority of STAs already possessing TWTs possess TWTs within the span 0-400 ms and/or where the majority of STAs not already possessing TWTs desire TWTs within the span 0-400 ms, but nevertheless a few STAs already possess and/or desire TWTs outside of 0-400 ms, the AP according to at least one example embodiment selects the first AID addressing hierarchy mode, and reassigns to STAs already possessing TWTs outside of 0-400 ms new TWTs falling within 0-400 ms and/or provides to STAs desiring TWTs outside of 0-400 TWTs within 0-400 ms. In such reassignment of TWTs and/or provision of TWTs other than those desired, the AP optionally attempts to provide STAs with TWTs as close as possible to those already held and/or those desired (e.g., a STA desiring a TWT outside of 0-400 ms is given a TWT towards the 400 ms end of 0-400 ms).

Further according to the illustrative example, the AP selects a TWT for the STA for which association is taking place, and also determines whether or not there will be an addressing change. Turning to the STA for which association is taking place, the AP indicates (e.g., via an association response frame) the chosen TWT to the STA implicitly by providing to the STA the AID which corresponds to that TWT (e.g., with the AP consulting precalculations in order to learn of the AID which correlates with the particular TWT and/or with the AP preforming a calculatory reverse on the discussed operations which take in an AID and output a corresponding TWT). The AP also indicates (e.g., via an association response frame) to the STA the addressing mode being employed (e.g., via an AID addressing hierarchy mode indicator conveyed via AID bits).

Still further according to the illustrative example, turning to already-associated STAs, where there is no change of addressing mode and where none of the already-associated STAs are to receive new TWTs, the AP need not communicate with the already-associated STAs responsive to the association of the new STA. Where there is a change of addressing mode and/or where one or more already-associated STAs are to receive new TWTs, the AP commences an AID reassignment phase (e.g., an IEEE 802.11ah AID reassignment phase). It is noted that under the circumstance where there is an addressing mode change, but where one or more already-associated STAs are to keep their existing TWTs, during the AID reassignment phase such STAs receive (e.g., via reassignment frame) AIDs which are possibly different, but which nevertheless map to the existing TWTs, with the new addressing mode being conveyed to those already-associated STAs (e.g., via an AID addressing hierarchy mode indicator conveyed via AID bits). For already-associated STAs receiving new TWTs, the AP indicates during the AID reassignment phase those new TWTs implicitly to those STAs by providing (e.g., via reassignment frame) to each such STA the AID which corresponds to that STA's new TWT. At least in the case of an addressing mode change, the AP further indicates to those STAs receiving new TWTs the current addressing mode (e.g., via an AID addressing hierarchy mode indicator conveyed via AID bits). In conveying TWTs implicitly to already-associated STAs, the AP, for instance, consults precalculations in order to learn of the AID which correlates with a particular TWT, and/or preforms a calculatory reverse on the discussed operations which take in an AID and output a corresponding TWT. The employment of an AID reassignment phase provides potential benefits including avoiding the disassociation of already-associated STAs, avoiding the performance of association with respect to already-associated STAs, and/or only performing association with respect to the STA for which association is taking place. In accordance with at least one example embodiment, the AP performs a new association with respect to one or more already-associated STAs rather than avoiding such new association by performing AID reassignment.

Additionally according to the illustrative example, according to one scenario association commences between an AP and a first STA (e.g., including the STA sending an association request to the AP), the STA optionally specifying one or more desired TWTs. The STA receives from the AP (e.g., via an association response frame) an AID which implicitly indicates the TWT to be employed by that STA, the AID also conveying (e.g., via the two most significant bits of the AID) the AID addressing mode being employed. Then, at a later point in time—such as in response to an association between the AP and a second STA—the AP switches to a new AID addressing hierarchy mode. Due to the new addressing mode, the first STA receives from the AP, via an AID reassignment phase, a new AID which conveys the new addressing mode (e.g., via an AID addressing hierarchy mode indicator conveyed via AID bits). Depending on the circumstances at hand and the determinations of the sort discussed above performed by the AP, the new AID implicitly conveys to the first STA either the STA's current TWT or a different TWT. As such, according to at least one example embodiment an AP performs on-the-fly change of AID addressing hierarchy mode, change of TWTs, and/or change of AIDs while a network made up of the AP and one or more associated STAs is operational.

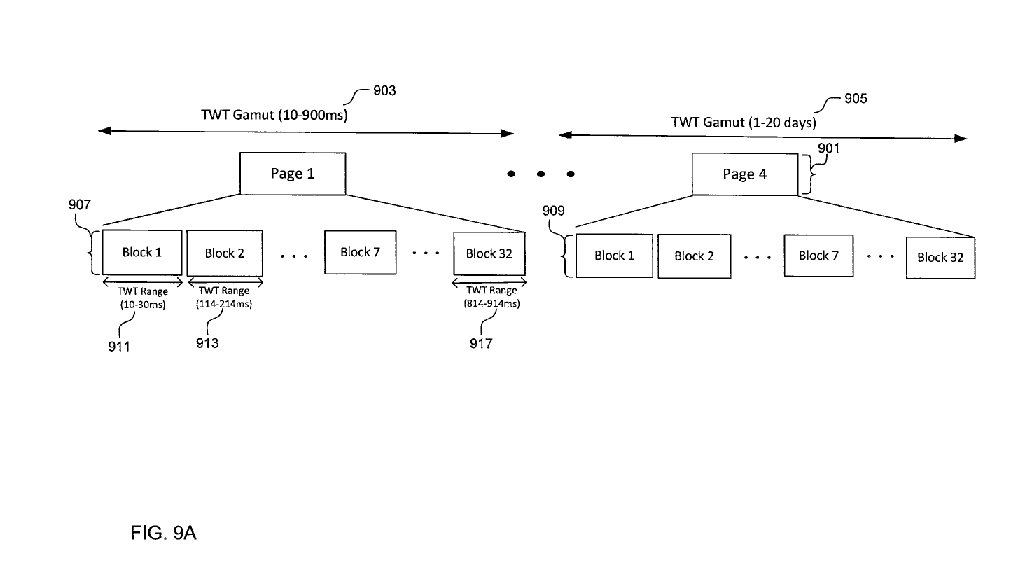

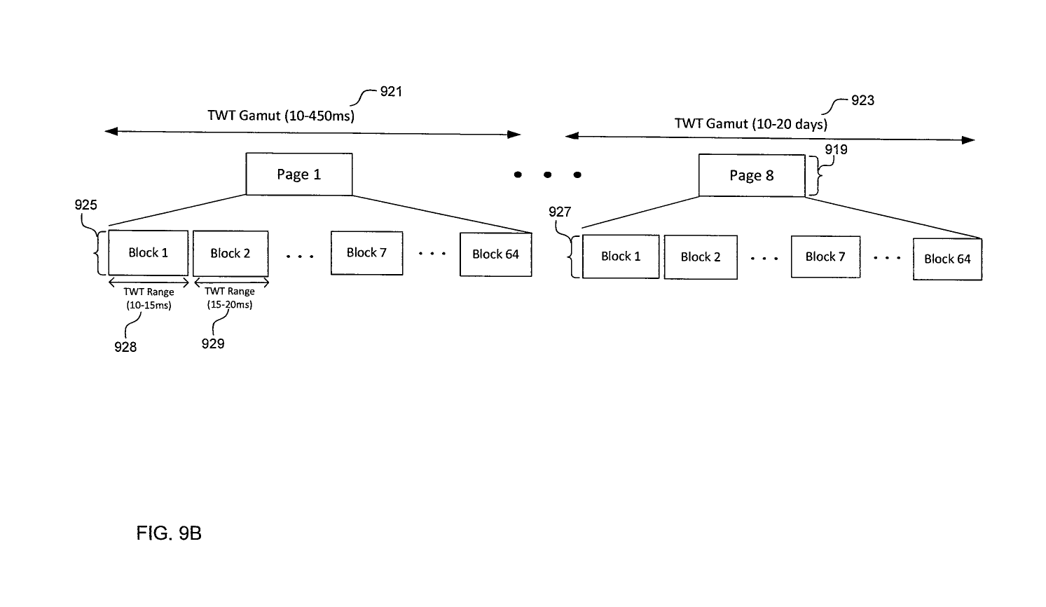

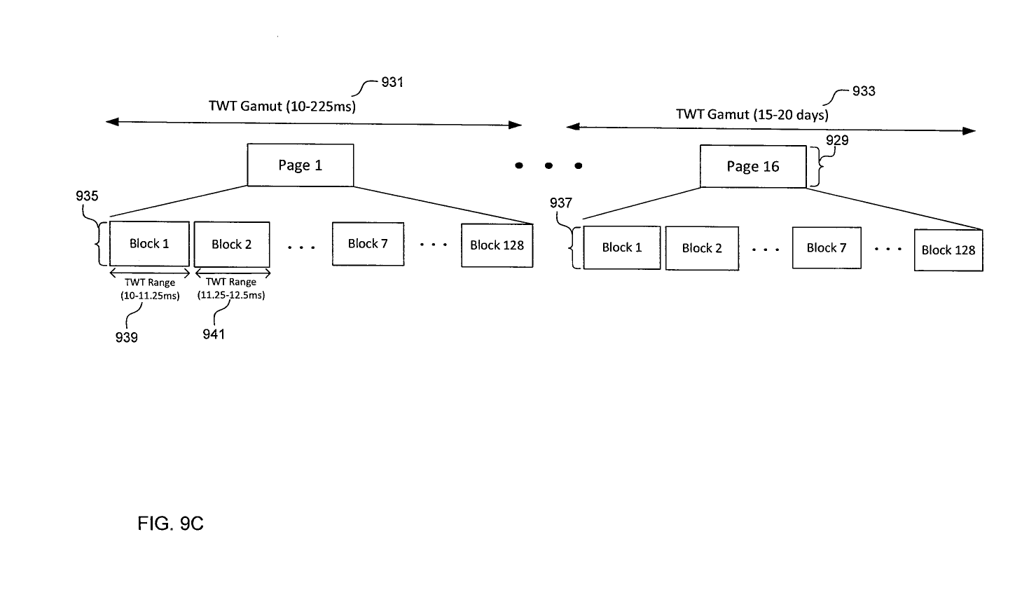

Also according to the illustrative example, shown in FIGS. 9A-9C are three further TWT hierarchical addressing correspondences in accordance with at least one example embodiment. The TWT hierarchical addressing correspondences of FIGS. 9A-9C apply respectively to the AID addressing hierarchy modes of FIGS. 2A-2C. The four pages (901) of FIG. 9A are page 1 through page 4. Pages 1 and 4 are explicitly shown, and pages 2 and 3 are conveyed via an ellipsis. Page 1 has a TWT gamut (903) which spans from 10-900 ms, page 2 has a TWT gamut which spans from 1-3500s, page 3 has a TWT gamut which spans from 1-24 hours, and page 4 has a TWT gamut (905) which spans from 1-20 days. Pages 1-4 each include 32 blocks. Depicted in FIG. 9A are the 32 blocks of page 1 (907), with blocks 1, 2, 7, and 32 being explicitly shown, and blocks 3-6 and 8-31 thereof being conveyed via ellipses. Also depicted in FIG. 9A are the 32 blocks of page 4 (909), with blocks 1, 2, 7, and 32 being explicitly shown, and blocks 3-6 and 8-31 thereof being conveyed via ellipses. Block 1 of page 1 has a TWT range (911) which spans from 10-30 ms, block 2 of page 1 has a TWT range (913) which spans from 114-214 ms, and block 32 of page 1 has a TWT range (917) which spans from 814-914 ms. To facilitate description, the TWT ranges of the other blocks of FIG. 9A are not discussed. Each block of FIG. 9A contains eight SBs, and each SB contains eight AID address locations. As such, block 1 of page 1, by virtue of having eight SBs each of which contains eight AID address locations, allows sixty-four STAs to have TWTs within the TWT time span 10-30 ms. Likewise, block 2 of page 1 allows 64 STAs to have TWTs within the time span 114-214 ms, and block 32 of page 1 allows sixty-four STAs to have TWTs within the time span 814-914 ms. To facilitate illustration, FIG. 9A does not depict SBs or AID address locations.

Further according to the illustrative example, the eight pages (919) of FIG. 9B are page 1 through page 8. Pages 1 and 8 are explicitly shown, and pages 2-7 are conveyed via an ellipsis. Page 1 has a TWT gamut (921) which spans from 10-450 ms, page 2 has a TWT gamut which spans from 451-900 ms, page 3 has a TWT gamut which spans from 1-1700s, page 4 has a TWT gamut which spans from 1701-3500s, page 5 has a TWT gamut which spans from 1-12 hours, page 6 has a TWT gamut which spans from 12.1-24 hours, page 7 has a TWT gamut which spans from 1-10 days, and page 8 has a TWT gamut which spans from 10.1-20 days.

Still further according to the illustrative example considering the AID addressing hierarchy mode of FIG. 9A with the AID addressing hierarchy mode of FIG. 9B, each TWT gamut of FIG. 9A is viewable as being subdivided so as to yield two TWT gamuts of FIG. 9B. By such view, the FIG. 9A TWT gamut of 10-900 ms is subdivided so as to yield the TWT gamuts 10-450 ms and 451-900 ms of FIG. 9B, the FIG. 9A TWT gamut of 1-3500s is subdivided so as to yield the TWT gamuts 1-1700s and 1701-3500s of FIG. 9B, the FIG. 9A TWT gamut of 1-24 hours is subdivided so as to yield the TWT gamuts 1-12 hours and 12.1-24 hours of FIG. 9B, and the FIG. 9A TWT gamut of 1-20 days is subdivided so as to yield the TWT gamuts 1-10 days and 10.1-20 days of FIG. 9B.

Also according to the illustrative example, pages 1-8 each include 64 blocks. Depicted in FIG. 9B are the 64 blocks of page 1 (925), with blocks 1, 2, 7, and 64 being explicitly shown, and blocks 3-6 and 8-63 thereof being conveyed via ellipses. Also depicted in FIG. 9B are the 64 blocks of page 8 (927), with blocks 1, 2, 7, and 64 being explicitly shown, and blocks 3-6 and 8-63 thereof being conveyed via ellipses. Block 1 of page 1 has a TWT range (928) which spans from 10-15 ms and block 2 of page 1 has a TWT range (929) which spans from 15-20 ms. Each block of FIG. 9B contains four SBs, and each SB contains four AID address locations. As such, block 1 of page 1, by virtue of having four SBs each of which contains four AID address locations, allows 16 STAs to have TWTs within the time span 10-15 ms. Likewise, block 2 of page 1 allows 16 STAs to have TWTs within the time span 15-20 ms. To facilitate illustration, FIG. 9B does not depict SBs or AID address locations.

Additionally according to the illustrative example, considering the AID addressing hierarchy mode of FIG. 9A with the AID addressing hierarchy mode of FIG. 9B, each TWT range of FIG. 9A is viewable as being subdivided so as to yield four TWT ranges of FIG. 9B. By such view, illustratively the FIG. 9A TWT range of 10-30 ms is subdivided so as to yield the TWT ranges 10-15 ms, 15-20 ms, 20-25 ms, and 25-30 ms (the first two such ranges being depicted in FIG. 9B and the second two ranges, to facilitate illustration, not being depicted in FIG. 9B).

Further according to the illustrative example, the 16 pages (929) of FIG. 9C are page 1 through page 16. Pages 1 and 16 are explicitly shown, and pages 2-15 are conveyed via an ellipsis. Each TWT gamut of FIG. 9B is viewable as being subdivided so as to yield two TWT gamuts of FIG. 9C. By such view, the FIG. 9B TWT gamut of 10-450 ms is viewable as being subdivided so as to yield in FIG. 9C the page 1 TWT gamut (931) which spans from 10-225 ms and the page 2 TWT gamut which spans from 226-450 ms, the FIG. 9B TWT gamut of 10-20 days is viewable as being subdivided so as to yield in FIG. 9C the page 15 TWT gamut which spans from 10-14 days and the page 16 TWT gamut (933) which spans from 15-20 days. The TWT gamuts of the other pages of FIG. 9C follow the same pattern linking the TWT gamuts of FIG. 9B and the TWT gamuts of FIG. 9C.

Still further according to the illustrative example, pages 1-16 each include 128 blocks. Depicted in FIG. 9C are the 128 blocks of page 1 (935), with blocks 1, 2, 7, and 128 being explicitly shown, and blocks 3-6 and 8-127 thereof being conveyed via ellipses. Also depicted in FIG. 9C are the 128 blocks of page 16 (937), with blocks 1, 2, 7, and 64 being explicitly shown, and blocks 3-6 and 8-127 thereof being conveyed via ellipses. Each block of FIG. 9C contains two SBs, and each SB contains 2 AID address locations. As such, each block allows four STAs to have TWTs within the time span established by its corresponding TWT range.

Also according to the illustrative example, each TWT range of FIG. 9B is viewable as being subdivided so as to yield four TWT ranges of FIG. 9C. By such view, the FIG. 9B TWT range of 10-15 ms is viewable as being subdivided so as to yield in FIG. 9C the page 1, block 1 TWT range (939) which spans from 10-11.25 ms, the page 1, block 2 TWT range (941) which spans from 11.25-12.5 ms, the page 1, block 3 TWT range which spans from 12.5-13.75 ms, and the page 1, block 4 TWT range which spans from 13.75-15 ms. The other TWT ranges of FIG. 9C follow the same patterning linking the TWT ranges of FIG. 9B and the TWT ranges of FIG. 9C.

Additionally according to the illustrative example, the AID addressing hierarchy mode of FIG. 9A is viewable as being appropriate where a large number of STAs have TWTs which are clumped closely together in value, with there being a lack of large swathes of time between TWTs. As a non-limiting example, such circumstances arise where there is a large number of TWTs within one or a few TWT ranges, with TWTs not being spread out over many TWT gamuts. As a particular example, the addressing mode of FIG. 9A is viewable as being appropriate where during the associations of 210 STAs 48 STAs request TWTs within 10-30 ms, 40 STAs request TWTs within 1-100s, 64 STAs request TWTs within 1-1.5 hours, and 58 STAs request TWTs within 1-2 days.

Further according to the illustrative example, the AID addressing hierarchy mode of FIG. 9C is viewable as being appropriate where there are instances of large swathes of time between TWTs, with there being a lack of large numbers of STAs having TWTs which are clumped closely together in value. As a non-limiting example, such circumstances arise where each TWT range possesses a small number of TWTs, but where TWTs are spread out over many TWT gamuts.

Still further according to the illustrative example, the AID addressing hierarchy mode of FIG. 9B is viewable as being appropriate for circumstances which fall between those discussed as being appropriate for the addressing mode of FIG. 9A and those discussed as being appropriate for the addressing mode of FIG. 9C. As a non-limiting example, such circumstances arise where there is a moderate number of TWTs within one or a few TWT ranges, with TWTs being spread out over a moderate number of TWT gamuts. As a particular example, the addressing mode of FIG. 9B is viewable as being appropriate where during the associations of 210 STAs, 100 STAs request TWTs within 10-30 ms, 80 STAs request TWTs within 1-100s, and the remainder of the 210 STAs request TWTs having values measured in hours and/or days.

### Hardware and Software

The foregoing discusses computers, such as the discussed AP and STA devices, performing a number of operations. Examples of computers include smart cards, media devices, personal computers, engineering workstations, PCs, Macintoshes, PDAs, portable computers, computerized watches, wired and wireless terminals, telephones, communication devices, nodes, servers, network access points, network multicast points, network devices, network stations, set-top boxes, personal video recorders (PVRs), game consoles, portable game devices, portable audio devices, portable media devices, portable video devices, televisions, digital cameras, digital camcorders, Global Positioning System (GPS) receivers, sensors, and wireless personal servers.

Running on such computers are often one or more operating systems. Examples of operating systems include Windows Phone (e.g., Windows Phone 8 or Windows Phone 7), Windows (e.g., Windows 8, Windows 7, or Windows Vista), Windows Server (e.g., Windows Server 2012, Windows server 2008, or Windows Server 2003), Maemo, Symbian OS, WebOS, Linux, OS X, and iOS. Supported by such computers are optionally one or more of the S60 Platform, the .NET Framework, Java, and Cocoa.

Examples of computers also include one or more processors operatively connected to one or more memory or storage units, wherein the memory or storage optionally contains data, algorithms, and/or program code, and the processor or processors execute the program code and/or manipulate the program code, data, and/or algorithms.

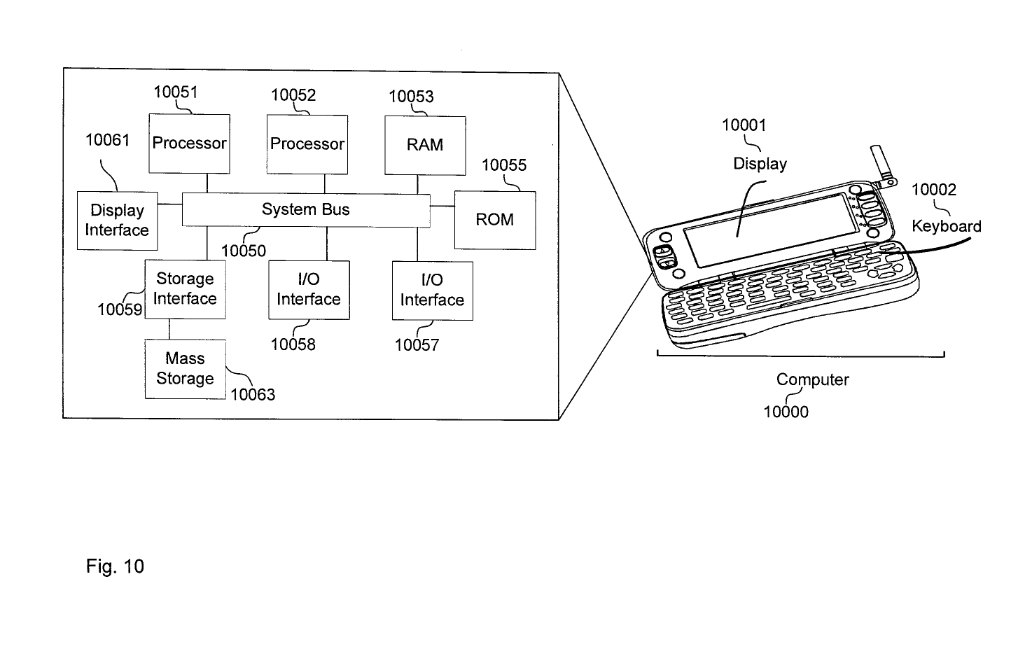

FIG. 10 shows example computer 10000 including system bus 10050 which operatively connects two processors 10051 and 10052, random access memory 10053, read-only memory 10055, input output (I/O) interfaces 10057 and 10058, storage interface 10059, and display interface 10061. Storage interface 10059 in turn connects to mass storage 10063. Each of I/O interfaces 10057 and 10058 is an Ethernet, IEEE 1394, IEEE 1394b, IEEE 802.11a, 802.11af, 802.11ah, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 10 mass storage 10063 is a hard drive or flash memory. Each of processors 10051 and 10052 is an ARM-based processor such as a Qualcomm Snapdragon or an x86-based processor such as an Intel Atom or Intel Core. Computer 10000 as shown in this example also includes a touch screen 10001 and physical keyboard 10002. Optionally a mouse or keypad is alternately or additionally employed. Moreover, one or more of touch screen 10001 and physical keyboard 10002 are optionally eliminated.

Additionally according to FIG. 10 computer 10000 optionally includes or is attached to one or more image capture devices. Examples of image capture devices include ones employing Complementary Metal Oxide Semiconductor (CMOS) hardware and ones employing Charge Coupled Device (CCD) hardware. One or more of the image capture devices are according to one example of an implementation aimed towards the user. Alternately or additionally, one or more of the image capture devices are aimed away from the user. The one or more image capture devices are optionally employed by computer 10000 for video conferencing, still image capture, and/or video capture. Moreover, computer 10000 optionally includes or is attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—is optionally loaded the code onto the computer via one or more of I/O interfaces 10057 and 10058, perhaps using one or more networks.

According to an example of an implementation, executed by computers discussed herein are one or more software modules designed to perform one or more of the discussed operations. Such modules are programmed using one or more languages. Examples of languages include C#, C, C++, Objective C, Java, Perl, and Python. Corresponding program code is optionally placed on media. Examples of media include DVD, CD-ROM, memory card, and floppy disk.

Any indicated division of operations among particular software modules is for purposes of illustration, and alternate divisions of operation are possible. Accordingly, any operations indicated to be performed by one software module are according to an alternative implementation instead performed by a plurality of software modules. Similarly, any operations indicated to be performed by a plurality of modules are according to an alternative implementation instead be performed by a single module.

Further, any operations indicated to be performed by a particular computer such as a particular device are according to an alternative implementation instead performed by a plurality of computers such as by a plurality of devices. Moreover, peer-to-peer, cloud, and/or grid computing techniques are optionally employed. Additionally, implementations include remote communication among software modules. Examples of remote communication techniques include Simple Object Access Protocol (SOAP), Java Messaging Service (JMS), Remote Method Invocation (RMI), Remote Procedure Call (RPC), sockets, and pipes.

Optionally, operations discussed herein are implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware is programed to perform operations discussed herein using one or more languages such as one or more Hardware Description Languages (HDLs). Examples of HDLs include very-high-speed integrated circuit hardware description language (VDHL) and Verilog.

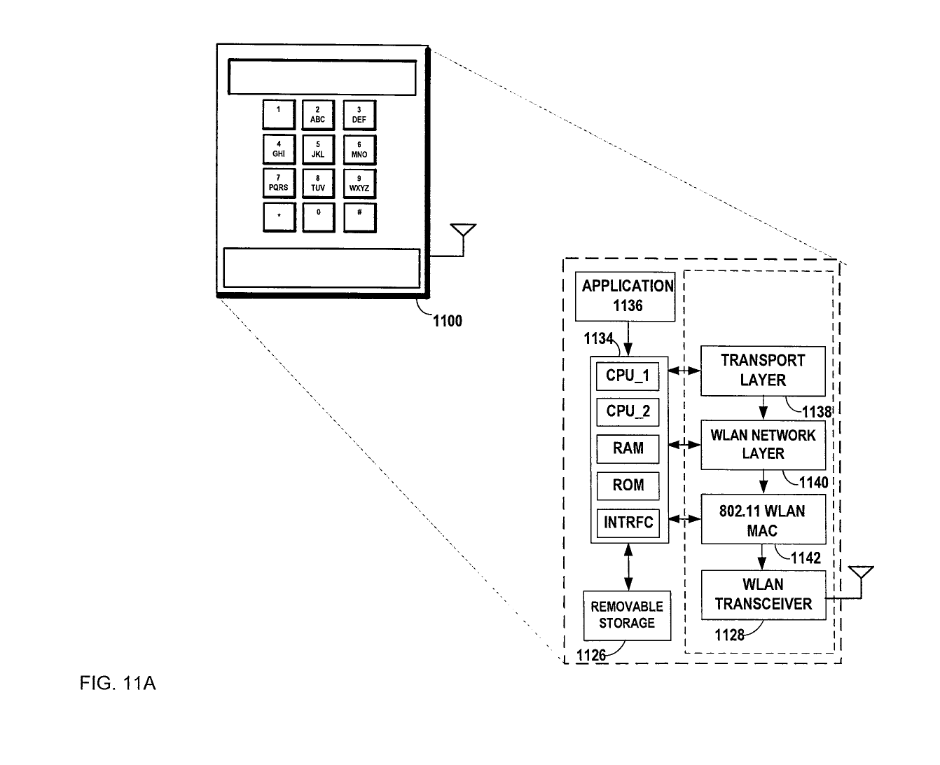

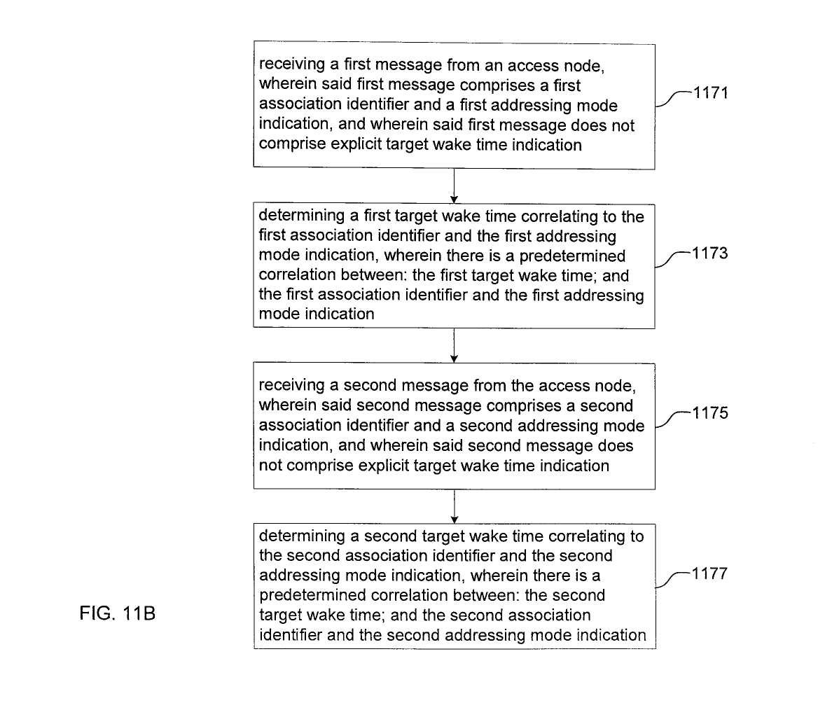

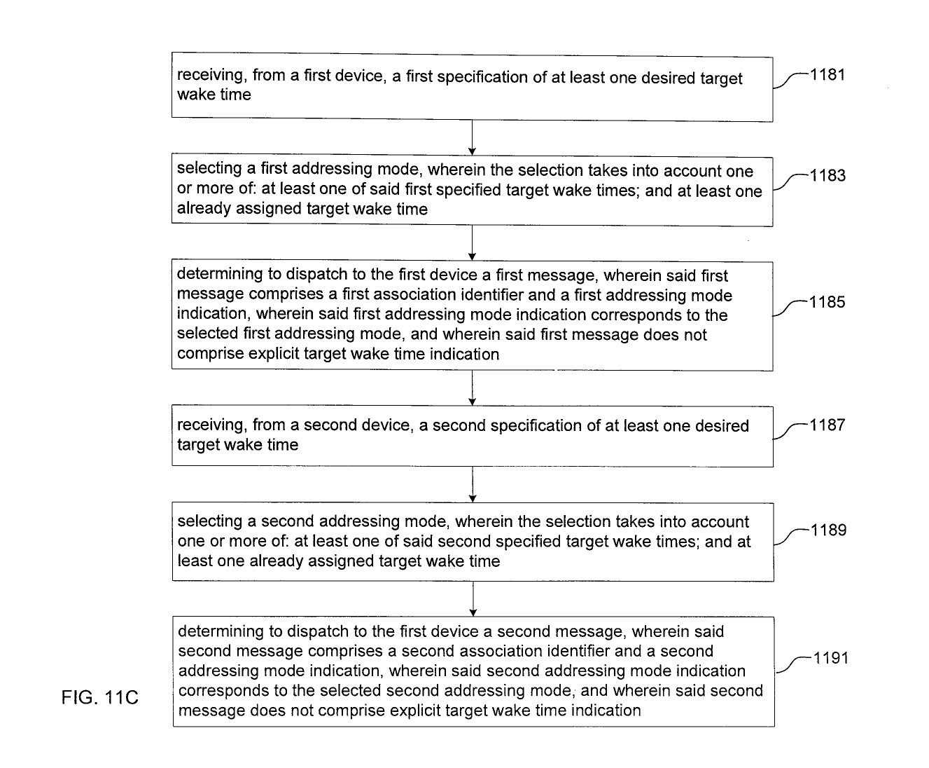

FIG. 11A is an example functional block diagram, illustrating an example AP or STA device 1100 according to an example embodiment of the invention. The example device 1100 includes a processor 1134 that includes dual or multi-core central processing units CPU_{—}1 and CPU_{—}2, a RAM memory, a ROM memory, and an interface for a keypad, display, and other input/output devices. The example device 1100 includes a protocol stack, including the transceiver 1128 and IEEE 802.11ah MAC 1142. The protocol stack includes a network layer 1140, a transport layer 1138, and an application program 1136.

In an example embodiment, the interface circuits in FIG. 11A interface with one or more radio transceivers, battery and other power sources, key pad, touch screen, display, microphone, speakers, ear pieces, camera or other imaging devices, etc. The RAM and ROM are optionally removable memory devices 1126 such as smart cards, subscriber identity modules (SIMs), wireless identification modules (WIMs), semiconductor memories such as RAM, ROM, PROMS, flash memory devices, etc. The processor protocol stack layers, and/or application program are according to an example of an implementation embodied as program logic stored in the RAM and/or ROM in the form of sequences of programmed instructions which, when executed in the CPU, carry out the functions of example embodiments. The program logic is according to an example of an implementation delivered to the writeable RAM, PROMS, flash memory devices, etc. from a computer program product or article of manufacture in the form of computer-usable media such as resident memory devices, smart cards or other removable memory devices. Alternately, they are embodied as integrated circuit logic in the form of programmed logic arrays or custom designed ASICs. The one or more radios in the device are separate transceiver circuits or alternately, the one or more radios are a single RF module capable of handling one or multiple channels in a high speed, time and frequency multiplexed manner in response to the processor. Examples of removable storage media 1126 include those based on magnetic, electronic, and/or optical technologies, such as magnetic disks, optical disks, semiconductor memory circuit devices, and micro-SD memory cards (SD refers to the Secure Digital standard) for storing data and/or computer program code as an example computer program product, in accordance with at least one embodiment of the present invention.

In an example embodiment of the invention, the device 1100 of FIG. 11A is a device, comprising:

at least one processor 1134;

at least one memory, RAM, ROM, and/or removable storage 1126 including computer program code represented by the flow diagram of FIG. 11B;

the at least one memory and the computer program code configured to, with the at least one processor, cause the device 1100 at least to:

receive a first message from an access node, wherein said first message comprises a first association identifier and a first addressing mode indication, and wherein said first message does not comprise explicit target wake time indication;

determine a first target wake time correlating to the first association identifier and the first addressing mode indication, wherein there is a predetermined correlation between: the first target wake time; and the first association identifier and the first addressing mode indication;

receive a second message from the access node, wherein said second message comprises a second association identifier and a second addressing mode indication, and wherein said second message does not comprise explicit target wake time indication; and

determine a second target wake time correlating to the second association identifier and the second addressing mode indication, wherein there is a predetermined correlation between: the second target wake time; and the second association identifier and the second addressing mode indication.

FIG. 11B discloses a flow diagram in accordance with at least one example embodiment of the present invention. 1171, 1173, 1175, and 1177 of FIG. 11B as a non-limiting example represent computer code instructions stored in the RAM and/or ROM memory of device 1100, which when executed by the central processing units (CPU), carry out the functions of an example embodiment of the invention. 1171, 1173, 1175, and 1177 are performable in another order than shown and are combinable and/or separable into component operations. As such:

1171: receiving a first message from an access node, wherein said first message comprises a first association identifier and a first addressing mode indication, and wherein said first message does not comprise explicit target wake time indication;

1173: determining a first target wake time correlating to the first association identifier and the first addressing mode indication, wherein there is a predetermined correlation between: the first target wake time; and the first association identifier and the first addressing mode indication;

1175: receiving a second message from the access node, wherein said second message comprises a second association identifier and a second addressing mode indication, and wherein said second message does not comprise explicit target wake time indication; and

1177: determining a second target wake time correlating to the second association identifier and the second addressing mode indication, wherein there is a predetermined correlation between: the second target wake time; and the second association identifier and the second addressing mode indication.

In a further example embodiment of the invention, the device 1100 of FIG. 11A is a device, comprising:

at least one processor 1134;

at least one memory, RAM, ROM, and/or removable storage 1126 including computer program code represented by the flow diagram of FIG. 11C;

the at least one memory and the computer program code configured to, with the at least one processor, cause the device 1100 at least to:

receive, from a first device, a first specification of at least one desired target wake time;

select a first addressing mode, wherein the selection takes into account one or more of: at least one of said first specified target wake times; and at least one already assigned target wake time;

determine to dispatch to the first device a first message, wherein said first message comprises a first association identifier and a first addressing mode indication, wherein said first addressing mode indication corresponds to the selected first addressing mode, and wherein said first message does not comprise explicit target wake time indication;

receive, from a second device, a second specification of at least one desired target wake time;

select a second addressing mode, wherein the selection takes into account one or more of: at least one of said second specified target wake times; and at least one already assigned target wake time; and

determine to dispatch to the first device a second message, wherein said second message comprises a second association identifier and a second addressing mode indication, wherein said second addressing mode indication corresponds to the selected second addressing mode, and wherein said second message does not comprise explicit target wake time indication.

FIG. 11C discloses a further flow diagram in accordance with at least one example embodiment of the present invention. FIG. 11C discloses a flow diagram in accordance with at least one example embodiment of the present invention. 1181, 1183, 1185, 1187, 1189, and 1191 of FIG. 11C as a non-limiting example represent computer code instructions stored in the RAM and/or ROM memory of device 1100, which when executed by the central processing units (CPU), carry out the functions of an example embodiment of the invention. 1181, 1183, 1185, 1187, 1189, and 1191 are performable in another order than shown and are combinable and/or separable into component operations. As such:

1181: receiving, from a first device, a first specification of at least one desired target wake time;

1183: selecting a first addressing mode, wherein the selection takes into account one or more of: at least one of said first specified target wake times; and at least one already assigned target wake time;

1185: determining to dispatch to the first device a first message, wherein said first message comprises a first association identifier and a first addressing mode indication, wherein said first addressing mode indication corresponds to the selected first addressing mode, and wherein said first message does not comprise explicit target wake time indication;

1187: receiving, from a second device, a second specification of at least one desired target wake time;

1189: selecting a second addressing mode, wherein the selection takes into account one or more of: at least one of said second specified target wake times; and at least one already assigned target wake time; and

1191: determining to dispatch to the first device a second message, wherein said second message comprises a second association identifier and a second addressing mode indication, wherein said second addressing mode indication corresponds to the selected second addressing mode, and wherein said second message does not comprise explicit target wake time indication.

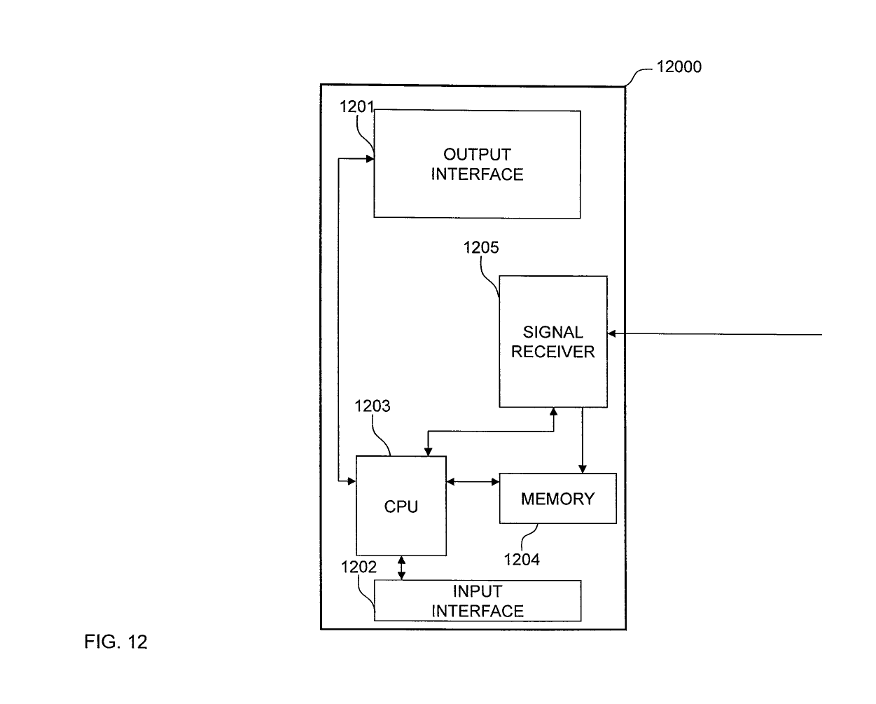

As noted, the foregoing discusses computers such as the discussed AP and STA devices. Shown in FIG. 12 is a block diagram of a further computer according to at least one example embodiment, terminal 12000. Terminal 12000 of FIG. 12 includes a processing unit CPU 1203, a signal receiver 1205, and a user interface (1201, 1202). Examples of signal receiver 1205 include single-carrier and multi-carrier receivers. Signal receiver 1205 and the user interface (1201, 1202) are coupled with the processing unit CPU 1203. One or more direct memory access (DMA) channels exist between multi-carrier signal terminal part 1205 and memory 1204. The user interface (1201, 1202) includes a display and a keyboard that enable a user to use the terminal 12000. In addition, the user interface (1201, 1202) includes a microphone and a speaker for receiving and producing audio signals. The user interface (1201, 1202) optionally employs voice recognition.

The processing unit CPU 1203 a microprocessor (not shown), memory 1204, and optionally software. The software is stored in the memory 1204. The microprocessor controls, on the basis of the software, the operation of the terminal 12000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 12, middleware or software implementation is optionally applied. Examples of terminal 12000 include a hand-held device such as a cellular mobile phone which includes the multi-carrier signal terminal part 1205 for receiving multicast transmission streams. Therefore, the terminal 12000 optionally interacts with service providers.

It is noted that although APs and STAs have been discussed at various junctures in connection with IEEE 802.11 so as to facilitate ease of discussion, the APs and STAs discussed herein are not limited to IEEE 802.11 APs and STAs. Non-limiting examples of APs discussed herein include access points (IEEE 802.11 and/or other than IEEE 802.11), access nodes, base stations, and other devices. Non-limiting examples of STAs discussed herein include stations (IEEE 802.11 and/or other than IEEE 802.11), mobile terminals, and other devices. APs and STAs discussed herein are, as non-limiting examples, of the networking modalities discussed above in connection with input output (I/O) interfaces 10057 and 10058.

Example embodiments of the invention include an apparatus, comprising:

means for receiving a first message from an access node, wherein said first message comprises a first association identifier and a first addressing mode indication, and wherein said first message does not comprise explicit target wake time indication;

means for determining a first target wake time correlating to the first association identifier and the first addressing mode indication, wherein there is a predetermined correlation between: the first target wake time; and the first association identifier and the first addressing mode indication;

means for receiving a second message from the access node, wherein said second message comprises a second association identifier and a second addressing mode indication, and wherein said second message does not comprise explicit target wake time indication; and

means for determining a second target wake time correlating to the second association identifier and the second addressing mode indication, wherein there is a predetermined correlation between: the second target wake time; and the second association identifier and the second addressing mode indication.

Example embodiments of the invention further include an apparatus, comprising:

means for receiving, from a first device, a first specification of at least one desired target wake time;

means for selecting a first addressing mode, wherein the selection takes into account one or more of: at least one of said first specified target wake times; and at least one already assigned target wake time;

means for determining to dispatch to the first device a first message, wherein said first message comprises a first association identifier and a first addressing mode indication, wherein said first addressing mode indication corresponds to the selected first addressing mode, and wherein said first message does not comprise explicit target wake time indication;

means for receiving, from a second device, a second specification of at least one desired target wake time;

means for selecting a second addressing mode, wherein the selection takes into account one or more of: at least one of said second specified target wake times; and at least one already assigned target wake time; and

means for determining to dispatch to the first device a second message, wherein said second message comprises a second association identifier and a second addressing mode indication, wherein said second addressing mode indication corresponds to the selected second addressing mode, and wherein said second message does not comprise explicit target wake time indication.

### RAMIFICATIONS AND SCOPE

Although the description above contains many specifics, these are merely provided to illustrate the invention and should not be construed as limitations of the invention's scope. For instance, various examples are articulated herein via the discussion of certain aspects. Such aspects are, themselves, merely examples and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
receiving, at a device, a first message from an access node, wherein said first message comprises a first association identifier and a first addressing mode indication, and wherein said first message does not comprise explicit target wake time indication;
determining, at the device, a first target wake time correlating to the first association identifier and the first addressing mode indication, wherein there is a predetermined correlation between:
the first target wake time; and
the first association identifier and the first addressing mode indication;
receiving, at the device, a second message from the access node, wherein said second message comprises a second association identifier and a second addressing mode indication, and wherein said second message does not comprise explicit target wake time indication; and
determining, at the device, a second target wake time correlating to the second association identifier and the second addressing mode indication, wherein there is a predetermined correlation between:
the second target wake time; and
the second association identifier and the second addressing mode indication.

2. The method of claim 1, further comprising determining, at the device, to send to the access node specification of at least one desired target wake time.

3. The method of claim 1, wherein the second message is received via an association identifier reassignment phase.

4. The method of claim 1, wherein the device receives the second association identifier without experiencing disassociation.

5. The method of claim 1, wherein the first message is received during association.

6. The method of claim 1, wherein one or more of:
said first message further comprises a duration corresponding to the first association identifier; and
said second message further comprises a duration corresponding to the second association identifier.

7. A method, comprising:
receiving, at an access node from a first device, a first specification of at least one desired target wake time;
selecting, at the access node, a first addressing mode, wherein the selection takes into account one or more of:
at least one of said first specified target wake times; and
at least one already assigned target wake time;
determining, at the access node, to dispatch to the first device a first message, wherein said first message comprises a first association identifier and a first addressing mode indication, wherein said first addressing mode indication corresponds to the selected first addressing mode, and wherein said first message does not comprise explicit target wake time indication;
receiving, at the access node from a second device, a second specification of at least one desired target wake time;
selecting, at the access node, a second addressing mode, wherein the selection takes into account one or more of:
at least one of said second specified target wake times; and
at least one already assigned target wake time; and
determining, at the access node, to dispatch to the first device a second message, wherein said second message comprises a second association identifier and a second addressing mode indication, wherein said second addressing mode indication corresponds to the selected second addressing mode, and wherein said second message does not comprise explicit target wake time indication.

8. The method of claim 7, wherein the second message is dispatched via an association identifier reassignment phase, and wherein said association identifier reassignment phase avoids device disassociation.

9. The method of claim 7, wherein said first message is dispatched during association.

10. The method of claim 7, wherein one or more of:
said first message further comprises a duration corresponding to the first association identifier; and
said second message further comprises a duration corresponding to the second association identifier.

11. An apparatus, comprising:
at least one processor; and
at least one memory including computer program code, the at least one memory and the computer program code configured to, with the at least one processor, cause the apparatus at least to perform:
receive, at the apparatus, a first message from an access node, wherein said first message comprises a first association identifier and a first addressing mode indication, and wherein said first message does not comprise explicit target wake time indication;
determine, at the apparatus, a first target wake time correlating to the first association identifier and the first addressing mode indication, wherein there is a predetermined correlation between:
the first target wake time; and
the first association identifier and the first addressing mode indication;
receive, at the apparatus, a second message from the access node, wherein said second message comprises a second association identifier and a second addressing mode indication, and wherein said second message does not comprise explicit target wake time indication; and
determine, at the apparatus, a second target wake time correlating to the second association identifier and the second addressing mode indication, wherein there is a predetermined correlation between:
the second target wake time; and
the second association identifier and the second addressing mode indication.

12. The apparatus of claim 11, wherein the at least one memory and the computer program code are further configured to, with the at least one processor, cause the apparatus to determine, at the apparatus, to send to the access node specification of at least one desired target wake time.

13. The apparatus of claim 11, wherein the second message is received via an association identifier reassignment phase.

14. The apparatus of claim 11, wherein the apparatus receives the second association identifier without experiencing disassociation.

15. The apparatus of claim 11, wherein the first message is received during association.

16. The apparatus of claim 11, wherein one or more of:
said first message further comprises a duration corresponding to the first association identifier; and
said second message further comprises a duration corresponding to the second association identifier.

17. An apparatus, comprising:
at least one processor; and
at least one memory including computer program code, the at least one memory and the computer program code configured to, with the at least one processor, cause the apparatus at least to perform:
receive, at the apparatus from a first device, a first specification of at least one desired target wake time;
select, at the apparatus, a first addressing mode, wherein the selection takes into account one or more of:
at least one of said first specified target wake times; and
at least one already assigned target wake time;
determine, at the apparatus, to dispatch to the first device a first message, wherein said first message comprises a first association identifier and a first addressing mode indication, wherein said first addressing mode indication corresponds to the selected first addressing mode, and wherein said first message does not comprise explicit target wake time indication;
receive, at the apparatus from a second device, a second specification of at least one desired target wake time;
select, at the apparatus, a second addressing mode, wherein the selection takes into account one or more of:
at least one of said second specified target wake times; and
at least one already assigned target wake time; and
determine, at the apparatus, to dispatch to the first device a second message, wherein said second message comprises a second association identifier and a second addressing mode indication, wherein said second addressing mode indication corresponds to the selected second addressing mode, and wherein said second message does not comprise explicit target wake time indication.

18. The apparatus of claim 17, wherein the second message is dispatched via an association identifier reassignment phase, and wherein said association identifier reassignment phase avoids device disassociation.

19. The apparatus of claim 17, wherein said first message is dispatched during association.

20. The apparatus of claim 17, wherein one or more of:
said first message further comprises a duration corresponding to the first association identifier; and
said second message further comprises a duration corresponding to the second association identifier.
